(19) United States
(12) Patent Application Publication
(10) Pub. No.: US 2025/0321768 A1
(43) Pub. Date: Oct. 16, 2025

(54) DIGITAL ASSISTANT SERVICE USING GENERATIVE ARTIFICIAL INTELLIGENCE

(71) Applicant: SAP SE, Walldorf (DE)

(72) Inventors: Sebastian Schuetz, Mannheim (DE); Julian Seibel, Hauenstein (DE); Jonas Kohlbrenner, Sinzheim (DE); Steffen Terheiden, Mannheim (DE); Jan Scheuermann, Mannheim (DE)

(21) Appl. No.: 18/632,969

(22) Filed: Apr. 11, 2024

(51) Int. Cl. G06F 9/451; G06N 3/0895

(52) U.S. Cl. CPC G06F 9/453; G06N 3/0895

(57) ABSTRACT

Examples described herein relate to a digital assistant that utilizes generative artificial intelligence. Prompt data provided to a generative machine learning model includes user input and function data. The function data can include dependency data that identifies at least one function dependency. A first function is invoked based on a first response from the generative machine learning model to obtain first output data. After updating the prompt data to include the first output data and receiving a second response from the generative machine learning model, a second function is invoked to obtain second output data. The digital assistant can maintain model-accessible data and non-model-accessible data for a digital conversation. Automated validation can be performed on parameter values of the first function or the second function. Parameter values may be explicitly confirmed by the digital assistant via a user-confirmation operation before invoking the first function or the second function.

### TECHNICAL FIELD

The subject matter disclosed herein generally relates to digital assistants. More specifically, but not exclusively, the subject matter relates to systems and methods that utilize generative artificial intelligence (AI) to provide a scalable digital assistant service.

### BACKGROUND

Various digital assistants, such as chatbots and other conversational agents, have been developed over the years. Digital assistants often rely on explicit conversation design, which can have technical drawbacks. For example, where user input goes beyond a simple reformulation of a digital assistant's training data, the digital assistant may be unable to correctly map the user input to an intended action. Moreover, digital conversations based on explicit conversation designs can typically only be handled according to a predetermined flow. For example, the digital assistant may be unable to unify separately provided user inputs, integrate contextual data items across messages, or recognize dependencies between data items.

### BRIEF DESCRIPTION OF THE DRAWINGS

Some examples are shown for purposes of illustration and not limitation in the figures of the accompanying drawings. In the drawings, which are not necessarily drawn to scale, like numerals may describe similar components in different views or examples. To identify the discussion of any particular element or act more easily, the most significant digit or digits in a reference number refer to the figure number in which that element is first introduced.

FIG. 1 is a diagrammatic representation of a network environment that includes a digital assistant service system, according to some examples.

FIG. 2 is a block diagram of components of a digital assistant service system, according to some examples.

FIG. 3 diagrammatically illustrates interaction of a digital assistant service system with a plurality of platforms, an external server, and a plurality of backend services, according to some examples.

FIG. 4 diagrammatically illustrates components of a conversation context that is maintained for a digital conversation in a digital assistant service system, according to some examples.

FIG. 5 is a block diagram illustrating prompt data provided to a generative machine learning model in a context of a digital assistant service system, according to some examples.

FIG. 6 is a flowchart illustrating operations of a method suitable for using a generative machine learning model in a digital assistant service system, wherein the digital assistant service system is enabled to recognize responses that trigger function calls, according to some examples.

FIG. 7 is a function dependency graph, according to some examples.

FIG. 8 is a diagrammatic illustration of function interdependencies, according to some examples.

FIG. 9 is a flowchart illustrating operations of a method suitable for using a generative machine learning model in a digital assistant service system, wherein the generative machine learning model leverages function data that includes function dependencies, according to some examples.

FIG. 10 diagrammatically illustrates a process for mapping dialog function parameters to model-obtainable parameters, according to some examples.

FIG. 11 is a flowchart illustrating operations of a method suitable for obtaining or classifying parameters during generation of prompt data in a digital assistant service system, according to some examples.

FIG. 12 is a user interface diagram illustrating part of a digital conversation within a digital assistant interface, according to some examples.

FIG. 13 is a function data diagram illustrating how function dependencies can be utilized by a generative machine learning model to obtain parameter values in a structured manner, according to some examples.

FIG. 14 is a flowchart illustrating operations of a method suitable for performing dynamic parameter validation in a digital assistant service system, according to some examples.

FIG. 15 diagrammatically illustrates training and use of a machine learning program, according to some examples.

FIG. 16 is a block diagram showing a software architecture for a computing device, according to some examples.

FIG. 17 is a block diagram of a machine in the form of a computer system, according to some examples, within which instructions may be executed for causing the machine to perform any one or more of the methodologies discussed herein.

### DETAILED DESCRIPTION

Examples described herein relate to a context-aware digital assistant that leverages generative AI. A “digital assistant,” as used herein, may include a software agent, application, or software-driven system that can interpret user input (e.g., user requests or user messages), execute or trigger associated actions, and provide relevant information back to the user, including through natural language conversations. Examples of digital assistants include chatbots, conversational agents, and voice assistants. While non-limiting examples described herein focus on text inputs and text outputs provided in a user interface (e.g., on a display of a user device), it is noted that a digital assistant may interact with a user via various modalities, such as text, speech, touch, or combinations thereof. The digital assistant may be provided by a digital assistant service via a web client at a user device.

As mentioned, digital assistants that are modeled on explicit conversation flows may have a limited ability to handle certain user inputs. For example, while such a digital assistant may perform well when user input is similar to the digital assistant's training data and follows an expected conversation flow, it may perform relatively poorly in tasks such as slot-filling when user inputs or conversation flows are significantly different than the digital assistant's training data. These and other technical issues may lead to suboptimal system performance or efficiency, limited functionality, or poor user experience.

Generative AI technology can be leveraged to enhance capabilities of a digital assistant. For example, a large language model (LLM) can be integrated into a digital assistant service system to improve the digital assistant's ability to understand user inputs, and to provide more diverse, natural, or engaging outputs. The use of LLMs can also obviate or reduce the need for explicit conversational design.

While generative AI has the potential to improve digital assistants, there are technical hurdles to providing an enterprise-ready digital assistant that can handle a diverse range of tasks at scale. Firstly, a digital assistant operating at scale would typically need to process large amounts of data for a range of scenarios (e.g., hundreds or even thousands of different business functions that a user may need assistance with). Each scenario can have its own parameters, or attributes, that need to be identified or described in model context. As a result, a large amount of data would need to be passed through the model context, increasing its size, cost, and runtime, or leading to situations in which the model's context reaches capacity mid-conversation (e.g., descriptions of hundreds or thousands of business functions might quickly fill the model's context window). This presents a technical challenge as it can lead to slower response times, reduced quality, incorrect outputs, or higher operational costs.

There is also a technical challenge in presenting business-specific terminology accurately to the user. In many scenarios, it is important that terminology maintained in backend systems is used consistently and not altered by a generative machine learning model during processing (e.g., in enterprise environments where specific terms may have precise definitions that need to be used consistently across functions). It may also be desirable to better protect sensitive business-critical information, such as by avoiding sending the information to an external LLM provider.

Technical problems can also arise in situations where there are dependencies between scenarios (e.g., functions) to be handled by a digital assistant. Complex business flows often require a sequence of interdependent actions. While a generative machine learning model, such as an LLM, may (in the absence of explicit dialog flow design) theoretically derive these dependencies from the data in its context window or based on its training, there is a risk that the generative machine learning model does not correctly derive a dependency or does not follow a particular sequence of operations. This lack of control can lead to errors or inefficiencies in the digital assistant's operations. Furthermore, where a generative machine learning model is non-deterministic, it may be difficult to fully prevent the generative machine learning model from inadvertently triggering functions (e.g., backend calls) that could lead to unauthorized actions or changes in a system.

Consider, for example, a scenario where a user asks a digital assistant to create a new job position within an organization. This process involves several steps, such as defining the job description, setting a salary range, and assigning a department, and there are dependencies between them. For instance, one cannot set a salary range before defining the job description, because the salary depends on the job's requirements. Allowing a generative machine learning model to create (or attempt to create) the new job position without understanding and strictly adhering to these rules or dependencies can have negative effects, both technically and practically.

In some examples of the present disclosure, a digital assistant leverages a large language model (LLM) to select and handle scenarios that are associated with respective functions. This may reduce or even obviate the need for manual or explicit definitions of conversation flows (e.g., there may be no need to define intents, entities, or slot-filling protocols). Instead, when a user inputs a query, a prompt is automatically generated that provides information such as a role definition (e.g., defines the “personality” of the digital assistant), a list of available functions, explanations of those functions and relationships between them, and conversation history data. The LLM may then process the prompt to generate one or more responses. In some examples, the LLM handles a selected scenario by obtaining parameter values needed to invoke a function corresponding to the selected scenario.

In some examples, a response generated by a generative machine learning model either represents a function call or provides a direct response to the query (e.g., a direct response that requests more information, provides general information that is not related to a function, or is intended as “small talk”). The term “function,” as used herein in the context of a digital assistant, refers to a capability that is accessible to, or can be leveraged by, the digital assistant, either directly or indirectly. For example, the digital assistant is enabled to invoke or cause invocation of a function by generating a function identifier and one or more parameter values (e.g., arguments) for one or more parameters of the function. Functions can range from relatively simple information retrieval operations, such as retrieving weather data or an invoice, to more complex or multi-step operations, such as creating and authorizing a purchase order or causing a financial transaction to occur. A function may define behavior that has a particular business focus or outcome. In some examples, execution of the function involves a call to a backend service (e.g., calling a “Get Purchase Orders” function (get_purchase_orders) to query purchase orders from a backend service).

An example method includes selecting, by a system as described herein, a set of functions from among a plurality of functions supported by a digital assistant. In some examples, the set of functions is a subset (e.g., 10, 20, or 30) of the plurality of functions (e.g., hundreds or thousands of supported functions) that is automatically selected based on at least one of the user input provided to the digital assistant, a user profile of the user, previous interactions with the digital assistant, function dependencies within the set of functions, or combinations thereof. For example, the user profile of the user might indicate access authorizations or role attributes of the user, that can be used to identify which functions are relevant or allowed to be presented to the user. As another example, the previous interactions can include a message history that indicates previously requested or discussed functions. Retrieval-augmented generation (RAG) may be utilized by a digital assistant service system to preselect a relevant set of functions for inclusion in the prompt data described below.

The method may further include generating and providing prompt data to a generative machine learning model (e.g., LLM). The prompt data includes user input and function data. The user input is received from a user via a user interface of the digital assistant, and the function data identifies the set of functions (e.g., via function identifiers).

The function data may describe various “scenarios” to the generative machine learning model, each corresponding or related to one or more functions. Accordingly, in some examples herein, the function data shared with the generative machine learning model defines scenarios.

In some examples, parameters of functions utilized by the digital assistant (such functions can be referred to as “dialog functions”) are mapped to parameters of scenarios handled by the generative machine learning model (such parameters can be referred to as “model-obtainable parameters”). For example, a parameter of a dialog function can be designated as a mandatory model-obtainable parameter if it must be obtained via the generative machine learning model for the function to be executed, or as an optional model-obtainable parameter if it can be obtained without using the generative machine learning model (or if it is simply an optional argument).

The function data may further include dependency data that includes a function dependency between a first function and a second function of the set of functions. For example, the function data can indicate that the first function is a helper function in relation to the second function. The digital assistant can thus be configured to enable its generative machine learning model (e.g., its LLM) to leverage dependencies between functions. For example, one or more parameter values for a first function can be fetched using a second function.

As used herein, the term “function dependency” refers to a relationship between at least two functions supported by a digital assistant. For example, the execution or output of one function is contingent upon the execution or output of another function. Alternatively, or additionally, while not necessarily contingent, one function can assist with retrieving a value of a parameter for another function. A function dependency may thus allow a generative machine learning model of a digital assistant to understand that a particular value can be obtained by calling another function, by asking the user for the value, or both, and allow the generative machine learning model to understand entry points or execution orders within a series of functions. For example, in a digital assistant environment, a function dependency might exist between a “Create Purchase Order” function and a “Get Purchase Requisition” function, such that the “Create Purchase Order” function cannot be executed until a purchase requisition identifier (ID) is obtained via the “Get Purchase Requisition” function.

A “helper function” is a function that can assist or support execution of another function, for example by performing a subsidiary task, a prerequisite task, or providing data needed to execute the other function. The function data provided to the generative machine learning model may indicate (e.g., via a function dependency graph or another dependency relationship data structure) relationships between functions and, for example, whether a function is a helper function with respect to another function.

The function data may thus indicate sources or potential sources for missing parameter values. Function dependencies can be set on parameter level, allowing explicit linking of different steps in larger process flows. For example, a helper function can act as a “value selector” that can assist the generative machine learning model to perform slot-filling for another function. These dependencies can be provided to the generative machine learning model as part of a parameter description.

As mentioned, the function data may identify a function dependency between a first function and a second function within the set of functions. The method may further include receiving a first response from the generative machine learning model that identifies the first function (e.g., it includes a function identifier of the first function together with parameter values for the first function). The first function is then invoked. The generative machine learning model causes invocation of the first function based on the function dependency (e.g., in order to subsequently utilize values that can be obtained via the first function). The prompt data is updated with first output data from invocation of the first function. The generative machine learning model then generates a second response that identifies the second function. In the second response, the generative machine learning model utilizes at least some of the first output data. The second function is then invoked to obtain second output data. In this way, the function dependency between the first function and the second function can be automatically leveraged to obtain the second output data (e.g., for presentation in the user interface of the digital assistant).

A system as described herein may maintain, for a digital conversation between the user and the digital assistant, model-accessible data and non-model-accessible data. The model-accessible data may include data elements or information that can be directly utilized by the generative machine learning model. The model-accessible data may include one or more of user inputs, function data (including, for example, a natural language description of one or more characteristics of each function in the set of functions, as well as function dependencies), conversation history, a role definition or other definitions to be used by the generative machine learning model, and other information that the generative machine learning model may need to generate responses or make decisions.

Accordingly, examples described herein maintain separate model-accessible data and non-model-accessible data for a digital conversation to reduce context size. To further reduce context size, certain parts of the model-accessible data may be summarized, compressed, or removed. For example, message history may be summarized or compressed, or older messages may be removed. To this end, the system may automatically perform operations such as summarization, semantic-based storing, or fetching of older conversation branches.

On the other hand, non-model-accessible data refers to data elements or information that are not directly provided to or processed by the generative machine learning model. The non-model-accessible data can include data used for backend processes, system operations, or by other components of the digital assistant service system. For example, the non-model-accessible data can include user information, system configuration settings, or technical parameters that are necessary for the system's functionality but are kept separate from model-accessible data to reduce model context size or to ensure data privacy, security, or system integrity.

In some examples, the non-model-accessible data includes technical context data. For example, a conversation context of a digital conversation can include the technical context data, which is not directly accessible to the generative machine learning model, and model-accessible data, such as user inputs or certain function data (e.g., scenario selections), which is directly accessible to the generative machine learning model, thereby creating a separation within the conversation context.

The technical context data may be used to manage execution of functions within a digital assistant. The technical context data can include one or more of system variables, Application Programming Interface (API) keys, session identifiers, and other technical details that are employed for correct functioning of the system but are not exposed to the end-user or the generative machine learning model. The technical context data may be used to store and exchange data between different functions. For example, it can contain variables of large numbers and size that are primarily technical and not visible to the user.

While the technical context data is not directly exposed to the generative machine learning model, dependencies on the technical context data may still be considered by the system during function selection or completion by the generative machine learning model. Dependencies on technical context may be referred to as “context dependencies.” A context dependency refers to the presence or potential presence of relevant data in the technical context data. For example, a function may have a parameter with a context dependency that indicates that a value for the parameter can be obtained from the technical context data. In some cases, user input can override a parameter value obtained from the technical context data.

The method may include identifying a context dependency (e.g., context variable path) of a parameter and accessing the non-model-accessible data to obtain a parameter value for the parameter from the technical context data. In some examples, the generative machine learning model is specifically not provided with access to this parameter value to keep context size smaller. In some cases, however, it may be beneficial for the generative machine learning model to obtain access to (previously) non-model-accessible data or to descriptions of such data. For example, a description of the parameter value for the aforementioned parameter is prepopulated in the prompt data based on the context dependency prior to passing the prompt data to the generative machine learning model. Therefore, where beneficial, the generative machine learning model can utilize certain data from or describing the non-model-accessible data that has been dynamically pulled into the model-accessible data by the digital assistant service system. Alternatively, or additionally, the parameter value is designated as an optional model-obtainable parameter in the prompt data to indicate to the generative machine learning model that obtaining the parameter value from the user, or via a function call, is not mandatory.

The prompt data may indicate a structured format in which to provide the response if the response is intended to trigger a function. For example, the prompt data may include a schema for function calling. The prompt data may also contain a description of the concept of function calling. In some examples, and as mentioned, the function data comprises, for each of the plurality of functions, a natural language description of one or more characteristics of the function. For example, for each function, a brief description of “what the function does,” in practical terms, may be included.

Based on the prompt data, the generative machine learning model may generate different types or categories of output, such as a function call or a direct response. A function call may include parameter values for the one or more parameters of the relevant function. A direct response may be a response that is directly passed to the user, such as a request to the user to provide additional values for a function call, conversational user experience outputs, “small talk,” information about the capabilities of the digital assistant, or information about a reason a previous response was given. Thus, in some examples, the direct response comprises a request for additional user input related to a function, or a non-function-related response (e.g., a response with a conversational focus).

Where the function data includes function dependencies, the prompt data may include an instruction to the generative machine learning model to adhere to one or more relations (e.g., dependencies, function execution orders, or entry points) defined by the dependency relationship data structure. For example, based on the function dependencies, a certain function cannot be selected as an entry point to a particular workflow, while another function can be selected as an entry point. In this context, an “entry point” refers to an initial function or scenario from which a sequence of actions begins in response to a user's query. Based on the prompt data, the generative machine learning model may be able to understand that certain functions cannot be used as entry points because they are, for example, dependent on the output of other functions or require specific conditions to be met before they can be executed.

The method may also include performing validation operations. For example, the method can include identifying, in the conversation context for a digital conversation between the user and the digital assistant, a function selected by the generative machine learning model, and identifying, in the conversation context, one or more new or modified parameter values provided by the user for one or more parameters of the selected function. A validation function is invoked to validate the one or more new or modified parameter values against one or more predefined criteria. The validation function may be repeatedly invoked for the same function or scenario until all mandatory parameter values have been provided and no new changes are detected by the system.

In some examples, the method includes detecting a failed validation. In response to detecting the failed validation, additional prompt data is generated by the system with details of the failed validation, and the additional prompt data is provided to the generative machine learning model to obtain an additional response. The additional response can include a user-directed message related to the failed validation, which the digital assistant causes to be presented in the user interface associated with the digital assistant. This can allow the user to better understand a potential reason for an error (e.g., incorrect format used in an input) and quickly address the error to trigger the desired function.

The method may also include performing explicit user confirmation operations. For example, the method can include, prior to invoking a function, causing presentation of a user-selectable approval element in the user interface together with a parameter value for one or more parameters of the function. In response to receiving the user selection of the user-selectable approval element, the function is invoked. Certain functions may be defined as needing explicit user approval. For example, the system may detect that the function may only be completed upon explicit user approval. In another example, the system may detect that certain information may only be presented to a user if the user enters the correct password. Explicit user confirmation may form part of a validation procedure or may be triggered in the digital assistant service system separately from the validation procedure.

The use of a generative machine learning model, such as an LLM, can allow a developer to provide significantly less input, with the generative machine learning model dynamically populating relevant data by extracting details from user input, conversation context, or function data. This may enable a developer to shift focus from “how to call a function,” to “what can the function do” and “how the function works together with other functions,” in the context of digital assistant design.

Examples described herein provide technical benefits when compared to digital assistants that require manual, explicit definition of intents, entities, slots, and conversation flows (e.g., dialog nodes and dialog trees), such as reducing input data requirements while providing more natural and diverse outputs. Relying on manually defined intents, entities, and rigid conversation flows requires extensive human effort to craft. This makes it challenging to handle variations in user input that go beyond predefined samples.

Conventional digital assistants may be constrained to hardcoded conversation flows and slot-filling logic explicitly authored by developers. This limits their ability to support natural, context-aware conversations that leverage information provided earlier in the conversation. By leveraging a generative machine learning model to dynamically interpret user input without needing manually defined intents and entities, these technical problems can be addressed or alleviated, enabling handling of a wider range of conversational variations.

When compared to a digital assistant that relies solely on an LLM (e.g., that sends user input to an LLM and returns all output directly to the user), examples described herein provide various technical benefits, such as the ability to explicitly define functions (e.g., business-critical functions) and function dependencies, and ensure reliable responses, while still leveraging the powerful and “creative” nature of an LLM. For example, a user can obtain benefits of generative AI through direct responses, while business-critical functions are still deterministically performed through the invocation of functions as described herein. This may allow an organization to have a greater level of control over business-critical functions.

Examples of the present disclosure can also facilitate the scaling of digital assistants that leverage generative AI, e.g., to allow the digital assistant to be effectively used by a large number of users and for a range of scenarios. Examples described herein can address or alleviate model context issues through a context handling approach that separates the context into model-accessible data and non-model-accessible data. By doing so, a system can significantly reduce the size of the context that needs to be passed to a generative machine learning model while still leveraging benefits of the generative machine learning model. For example, by only allowing the generative machine learning model to directly access the model-accessible data, but still utilizing certain non-model-accessible data to facilitate function calling, this approach ensures that the digital assistant operates efficiently with a streamlined context, leading to faster response times and cost savings without compromising the quality of the interaction.

In some examples, the separation of overall context into two portions, model-accessible data and non-model-accessible data, allows the representation of complex business scenarios where selected functions rely on data of previous conversation steps. At the same time, large variables and technical information that are not visible to the user or to the generative machine learning model can be processed in a manner that keeps generative machine learning model costs and response times lower.

As mentioned, managing dependencies between various functions or tasks within a digital assistant can be technically challenging. Examples described herein can reduce errors or incomplete digital assistant workflows by defining, within the prompt data, function dependencies. In some examples, function dependencies are defined using semantic triples that a generative machine learning model can interpret, ensuring that functions are executed in the correct order with all necessary prerequisites satisfied. As a result, the digital assistant can navigate relatively complex workflows (e.g., workflows that cannot be derived from the “general knowledge” of an LLM) with greater efficiency or precision, while still providing a flexible conversational flow between the user and the digital assistant.

Examples described herein also provide a robust validation mechanism for user-provided parameters. Validation techniques may be performed at an individual parameter level, for a set of parameters of a function, or both, before a final action is invoked. If a validation fails, the user can be automatically prompted with useful information (e.g., generated by an LLM) to correct the relevant values. This may enhance the reliability, accuracy, or security of the digital assistant's operations.

Due to its non-deterministic nature, some generative machine learning models, such as LLMs, may trigger incorrect actions or backend calls without a user's explicit consent if a digital assistant service system is not designed with appropriate safeguards. To mitigate this risk, examples of the present disclosure incorporate explicit confirmation steps into a digital assistant's workflow. In some cases, non-model-accessible data, such as technical context data, is used to help a user confirm an instruction, to ensure that information is correct, or to reduce the risk of an incorrect action being triggered. This provides an additional layer of security and user control, ensuring that backend systems are only engaged with the user's informed consent. For example, a confirmation mechanism that is performed outside of the model-accessible part of the context may prevent an LLM from triggering generation of a business object without explicit user consent.

When the effects in this disclosure are considered in aggregate, one or more of the methodologies described herein may obviate a need for certain efforts or resources that otherwise would be involved in developing, deploying, or scaling digital assistants. Computing resources utilized by systems, devices, databases, or networks may be more efficiently utilized or reduced, e.g., as a result of a reduced or obviated requirement to design, input, and process conversation flows, intents, entities, dialog trees, or the like, as a result of a reduction in the amount of data to be processed by a generative machine learning model, or as a result of improved accuracy and reliability due to the use of a dependency-driven function architecture. Examples of such computing resources may include processor cycles, network traffic, memory usage, data storage capacity, power consumption, and cooling capacity.

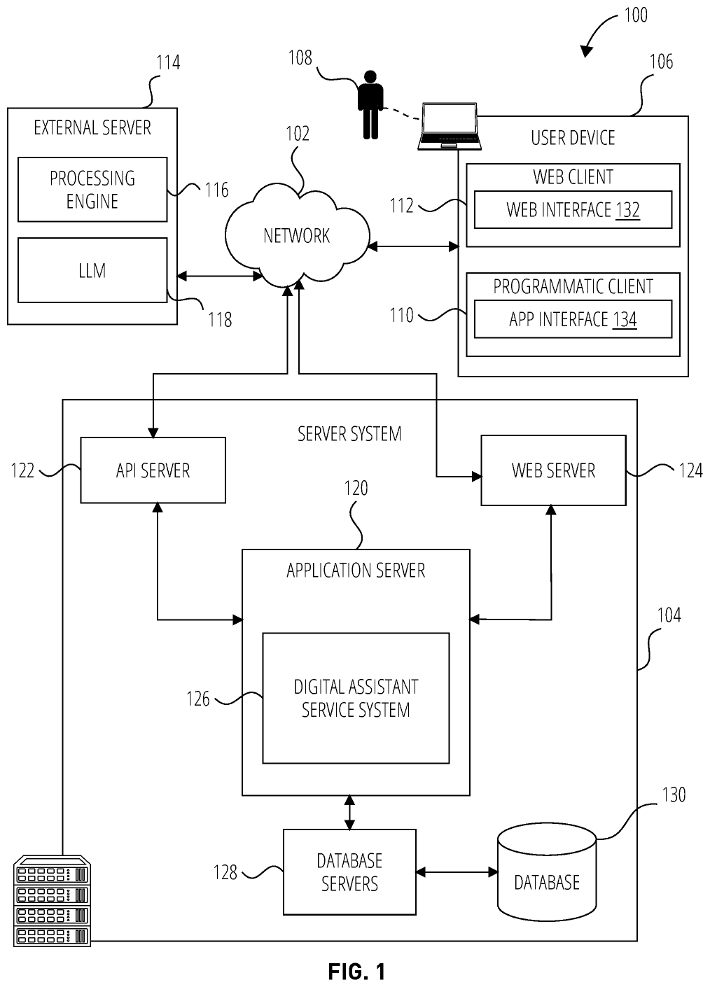

FIG. 1 is a diagrammatic representation of a networked computing environment 100 in which some examples of the present disclosure may be implemented or deployed. One or more servers in a server system 104 provide server-side functionality via a network 102 to a networked device, in the example form of a user device 106 that is accessed by a user 108. A web client 112 (e.g., a browser) or a programmatic client 110 (e.g., an “app”) may be hosted and executed on the user device 106.

An API server 122 and a web server 124 provide respective programmatic and web interfaces to components of the server system 104. A specific application server 120 hosts a digital assistant service system 126, which includes components, modules, or applications. It will be appreciated that the digital assistant service system 126 may be hosted across multiple application servers in other examples.

The user device 106 can communicate with the application server 120. For example, the user device 106 can communicate with the application server 120 via the web interface supported by the web server 124 or via the programmatic interface provided by the API server 122. It will be appreciated that, although only a single user device 106 is shown in FIG. 1, a plurality of user devices may be communicatively coupled to the server system 104 in some examples. For example, multiple users access the digital assistant service system 126 using respective user devices to utilize its functionality. Further, while certain functions may be described herein as being performed at either the user device 106 (e.g., web client 112 or programmatic client 110) or the server system 104, the location of certain functionality either within the user device 106 or the server system 104 may be a design choice.

The application server 120 is communicatively coupled to database servers 128, facilitating access to one or more information storage repositories, such as database 130. In some examples, the database 130 includes storage devices that store information to be processed by the digital assistant service system 126 or other components shown in FIG. 1. For example, the database 130 may store function data associated with functions supported by a digital assistant. The function data may be updated periodically such that the digital assistant supports a dynamic set of functions.

The application server 120 accesses application data (e.g., application data stored by the database servers 128) to provide one or more applications or software tools to the user device 106 via a web interface 132 or an app interface 134. In particular, the user 108 is enabled to access a digital assistant provided by the digital assistant service system 126 via the user device 106.

The digital assistant service system 126 functions to handle user interactions and fulfillment of capabilities for the digital assistant. The digital assistant service system 126 includes various components to interpret user input, determine and invoke appropriate functions, generate responses, and integrate with external systems.

In some examples, the digital assistant service system 126 enables natural language conversations by receiving user input, analyzing input to determine appropriate responses, calling or triggering the calling of functions to execute capabilities, and generating conversational responses. The digital assistant service system 126 maintains context to enable conversations/dialogs spanning multiple exchanges. The digital assistant service system 126 may provide a modular architecture that integrates external systems and functions (e.g., via standardized interfaces).

The digital assistant service system 126 can integrate or communicate with a variety of platforms and endpoints. For example, the user 108 can access the digital assistant provided by the digital assistant service system 126 via the web client 112 or the programmatic client 110, and interact with the digital assistant via the web interface 132 or the app interface 134.

In some examples, the user 108 uses the web interface 132 of the web client 112 of the user device 106 to access the environment provided by the digital assistant service system 126. For example, the web client 112 may transmit instructions to and receive responses from the server system 104 to allow it to update a user interface, creating a dynamic and interactive web application experience. In some examples, the digital assistant is provided as a support tool that is presented as a window in association with a primary application. The digital assistant service system 126 may add an AI-powered, conversational experience “on top of” a standard user interface provided by the web client 112 and web interface 132 at the user device 106.

In other examples, at least parts of the digital assistant may run on the web client 112, and its user interface can be updated without transmitting instructions to and receiving responses from the server system 104. Accordingly, while the digital assistant service system 126 is shown as residing within the server system 104 in FIG. 1, it will be appreciated that functionality or features of the digital assistant service system 126 may be provided so as to run at least partially at the user device 106.

In some examples, the digital assistant service system 126 provides AI-assisted or AI-driven digital assistant services that include natural language interactions and interpretation. The digital assistant service system 126 may receive user queries, generate and provide prompts to a machine learning model to obtain responses to user queries, assist with identifying scenarios and triggering functions, and present responses to the user 108. Accordingly, the digital assistant service system 126 may allow the user 108 to ask natural language questions or submit natural language requests, related, for example, to an application that the user 108 is working with or to a business function that the user 108 would like to perform.

The machine learning model may be hosted on an external server 114 that provides a processing engine 116 and a trained model, such as an LLM 118 (as an example of a generative machine learning model), as shown in FIG. 1. However, in other examples, the machine learning model can be internally hosted.

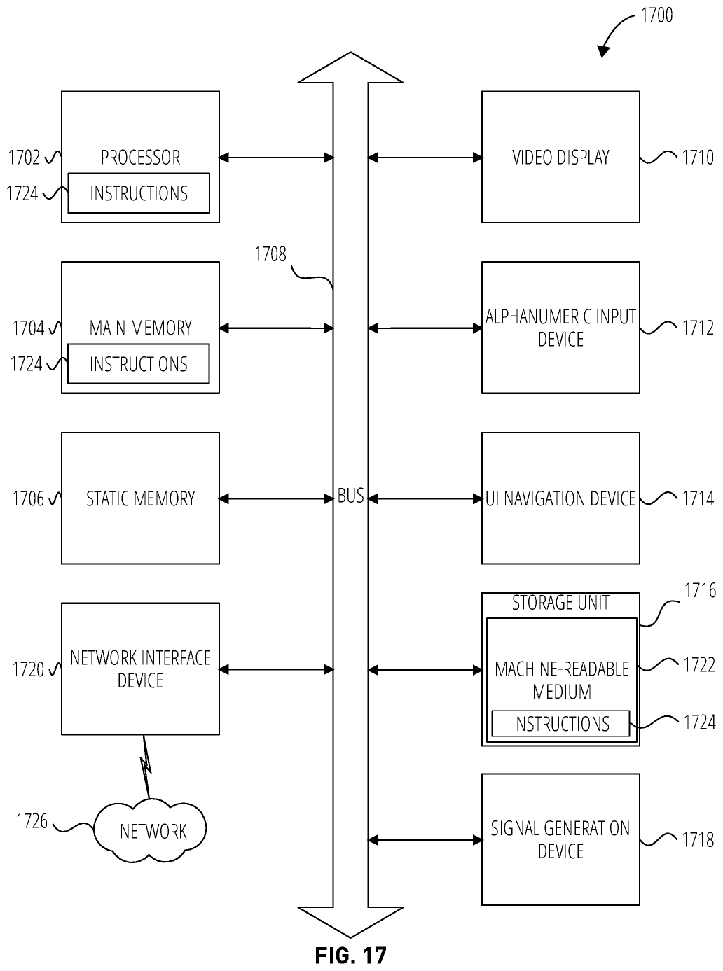

In some examples, the application server 120 is part of a cloud-based platform provided by a software provider that allows the user 108 to utilize the features of the digital assistant service system 126. One or more of the application server 120, the database servers 128, the API server 122, the web server 124, and the digital assistant service system 126, or parts thereof, may each be implemented in a computer system, in whole or in part, as described below with respect to FIG. 17.

In some examples, external applications (which may be third-party applications), such as applications executing on the external server 114, can communicate with the application server 120 via the programmatic interface provided by the API server 122. For example, a third-party application may support one or more features or functions on a website or platform hosted by a third party, or may perform certain methodologies and provide input or output information to the application server 120 for further processing or publication.

Referring more specifically now to the external server 114, the external server 114 houses the LLM 118 and related processing capabilities. The external server 114 may provide an external, scalable server environment dedicated to running and serving queries to the LLM 118.

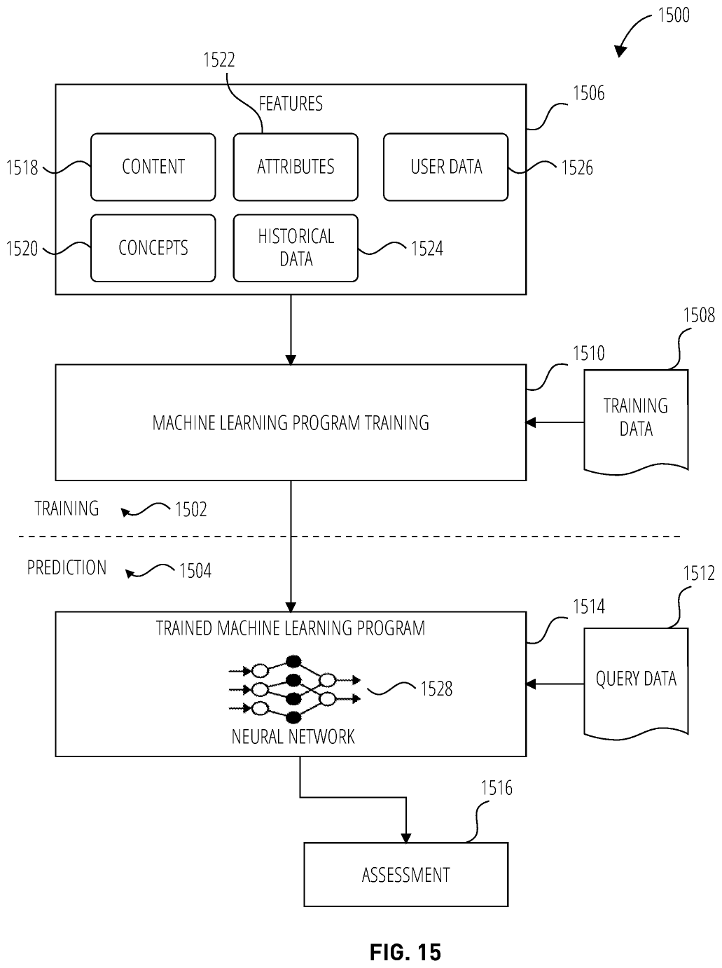

The LLM 118 is a computational model developed for the tasks of processing, generating, and understanding human language. It employs machine learning methodologies, including deep learning architectures. The training of the LLM 118 may utilize comprehensive data sets, such as vast data sets of textual content, to enable the LLM 118 to recognize patterns in human language. The LLM 118 may be built upon a neural network framework, such as the transformer architecture. The LLM 118 may contain a significant number of parameters (e.g., in excess of a billion), which are adjusted during training to optimize performance. Machine learning techniques are described in greater detail with reference to FIG. 15.

The processing engine 116 may be a component running on the external server 114 that is communicatively coupled to the LLM 118. The processing engine 116 may handle certain preprocessing of data before sending it to the LLM 118 and certain postprocessing of the responses received from the LLM 118. For preprocessing, the processing engine 116 may tokenize, compress, or format the data to optimize it for the LLM 118. For postprocessing, it may format the LLM 118 response, perform detokenization or decompression, and prepare the response for sending back to the requesting system (e.g., the digital assistant service system 126).

The LLM 118 may provide natural language processing capabilities that can assist with user queries, understanding context or instructions, identifying functions of interest, identifying further information required to perform functions, understanding dependencies between functions or actions, invoking function calls, and generating natural language responses. In some examples, the LLM 118 has been fine-tuned on relevant tasks and conversations to enhance its ability to provide useful responses, insights, or solutions. For example, the LLM 118 may be fine-tuned to focus specifically on queries relating to functions and to provide function call responses in a particular format (e.g., JavaScript Object Notation (JSON) format). The digital assistant service system 126 may thus integrate with the LLM 118 to add a human-like, conversational interface for users interacting with a digital assistant.

The network 102 may be any network that enables communication between or among machines, databases, and devices. Accordingly, the network 102 may be a wired network, a wireless network (e.g., a mobile or cellular network), or any suitable combination thereof. The network 102 may include one or more portions that constitute a private network, a public network (e.g., the Internet), or any suitable combination thereof.

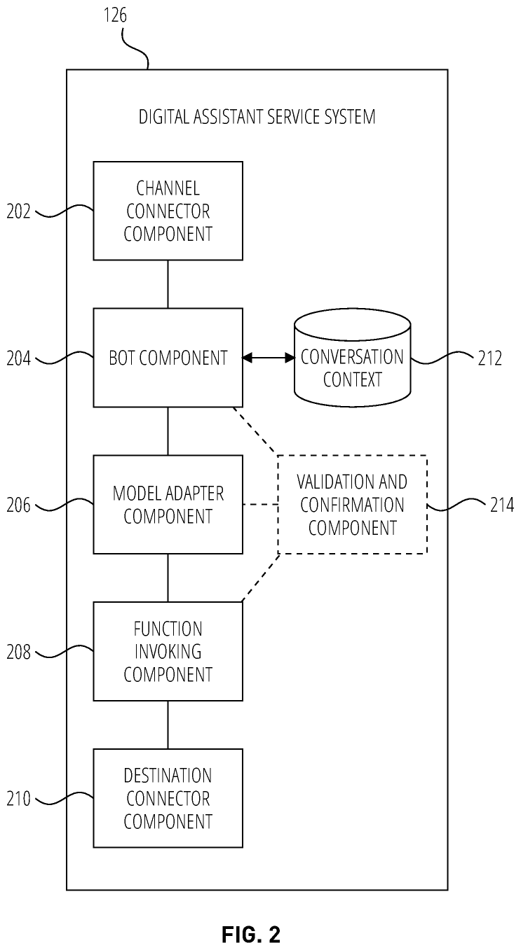

FIG. 2 is a block diagram illustrating certain components of the digital assistant service system 126 of FIG. 1, according to some examples. The digital assistant service system 126 is shown to include a channel connector component 202, a bot component 204, a model adapter component 206, a function invoking component 208, a destination connector component 210, and a conversation context 212.

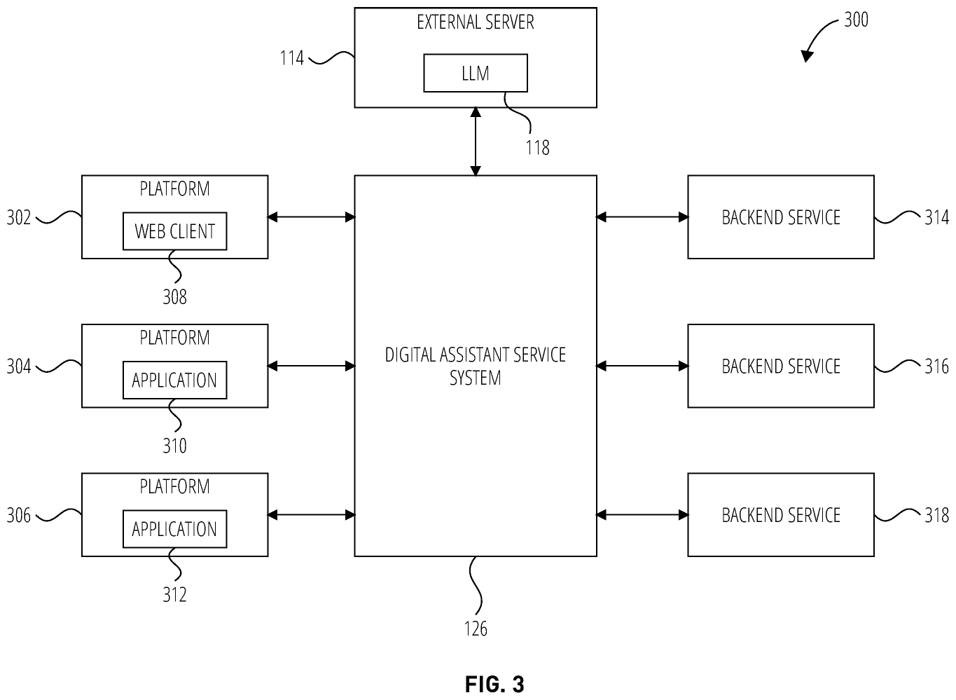

The channel connector component 202 serves as an interface to external user systems and devices accessing the digital assistant. The channel connector component 202 is configured to handle or translate various protocols and data formats to normalize communications between user devices and the digital assistant service system 126. This enables support for devices accessing the digital assistant via different channels (as is further described with reference to FIG. 3). The digital assistant may be configured to support multiple message types in addition to plain text (e.g., messages including images) or handle voice inputs. The channel connector component 202 provides front-end integration functionality allowing, for example, the user 108 to open an application in the web client 112 and interact with the digital assistant via a chat window.

The bot component 204 is responsible for receiving user input to the digital assistant from the channel connector component 202. In cases where the digital assistant service system 126 provides access to multiple different digital assistants, the bot component 204 may direct user input to the correct digital assistant.

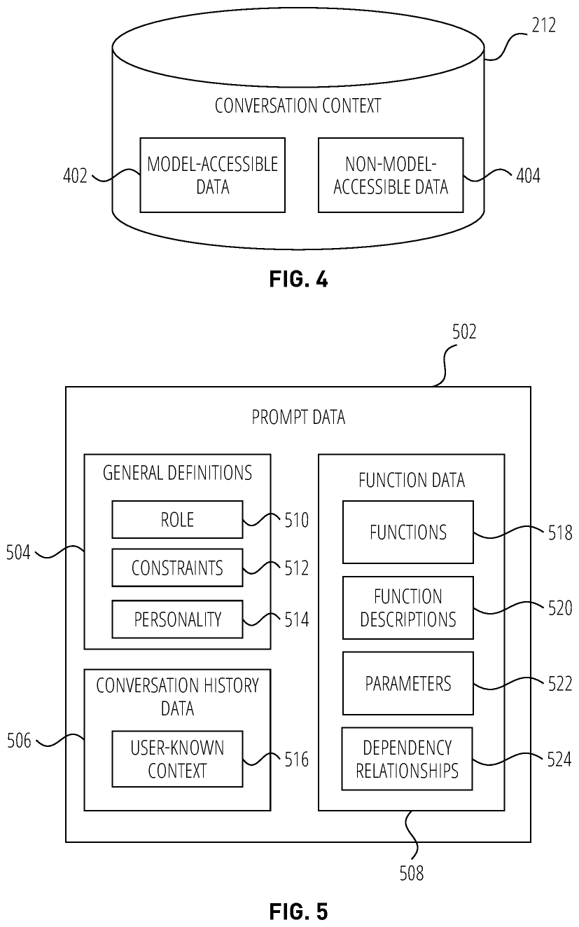

The bot component 204 also manages a conversation context 212, as is further described with reference to FIG. 4. In some examples, upon receiving a new user message, the bot component 204 transmits the new user message together with the latest set of other data (e.g., conversation history or function data), to be included in a prompt, to the model adapter component 206.

In some examples, the conversation context 212 stores not only the history of a current session between the user 108 and the digital assistant, but also the conversation history data of one or more previous sessions between the user 108 and the digital assistant, thereby enhancing the ability of the digital assistant to, for example, resolve co-references. In other words, when a prompt is generated, it may include details of earlier conversations between the user and the digital assistant. The conversation history data may be stored as context, for example, in a context window of the generative machine learning model.

The conversation context 212 may be dynamically updated, for example, to ensure that the conversation history data does not take up more than a threshold portion of the context window. For example, the bot component 204 may automatically select only the most relevant or potentially relevant functions to be included in the prompt data (although this operation may be performed by the model adapter component 206 in some examples), delete older parts of the conversation history data, or automatically summarize the conversation history data to reduce its overall token size. The bot component 204 can also dynamically modify portions of the conversation context 212, for example, by retrieving values from technical context data that are not exposed to a generative machine learning model and adding the values into the prompt data that is exposed to the generative machine learning model.

The bot component 204 may be responsible for efficiently managing the conversation context 212 with respect to a particular session or conversation. Examples described herein may reduce memory requirements given that, for example, fewer variables may need to be explicitly defined and stored (e.g., intents, entities, structured flows, and explicit conversation state information).

The model adapter component 206 serves as an adapter layer between a bot runtime and a generative machine learning model. The model adapter component 206 is responsible for generating or finalizing prompt data to provide to the generative machine learning model (e.g., the LLM 118, which is referred to below as a non-limiting example). For example, the model adapter component 206 takes data received from the bot component 204, which may include model-accessible data within the conversation context 212, such as user messages and scenario selections, and adds additional data to generate the prompt data. The model adapter component 206 may add function data that identifies a set of functions available to the digital assistant and describes their characteristics (e.g., what they do), parameters (e.g., the arguments needed to call the function), and dependencies.

In some examples, the model adapter component 206 is responsible for mapping parameters of functions supported by the digital assistant, referred to as “dialog functions,” to parameters of scenarios or “model functions” handled by the generative machine learning model. For example, for each parameter of a selected function, the model adapter component 206 may determine whether the parameter should be made optional or mandatory for the generative machine learning model to obtain, thus mapping each “dialog function parameter” to a corresponding “model-obtainable parameter.” The bot component 204 or the model adapter component 206 may make this determination based on whether certain parameter values can be obtained without needing the generative machine learning model to ask the user for them, or to call functions to retrieve them.

The model adapter component 206 may also add other data to the prompt data, such as a role definition. In some examples, a function does not have any parameters (e.g., the function data identifies the function and its characteristics, but not necessarily parameters). Various types of additional contextual information can be provided to the generative machine learning model to guide it with respect to its task or certain output requirements, such as a desired level of detail, format, and style.

In some examples, function data that identifies relevant functions, their parameters, and characteristics, is part of model-accessible data in the conversation context 212 and is passed to the model adapter component 206 by the bot component 204. In other examples, such function data is not included in the conversation context 212 and is added by the model adapter component 206 when generating a final prompt.

The generative machine learning model is responsible for natural language processing, conversation generation, function resolution, and slot filling (where needed to complete a function call, for example). The model adapter component 206 may parse the response received from the generative machine learning model to determine a response type. For example, the model adapter component 206 may determine whether the response is a function call or a direct response. If the response is a direct response, the model adapter component 206 may return the response directly to the bot component 204 to cause the response to be presented at a user device. If the response is a function call, the function call is transmitted to the function invoking component 208. The model adapter component 206 may detect that the response is a function call based on a structure or schema of the response, or some other function identifier.

The model adapter component 206 may handle integration with API endpoints, such as one or more API endpoints of the LLM 118 (e.g., by communicating with the processing engine 116 of the external server 114). The prompt data may be transmitted to the LLM 118 as a single prompt. Alternatively, different portions of the prompt data may be provided separately. For example, the function data or other data, such as a role definition, may be provided as a “pre-prompt” portion of the prompt data, given that such data would be included in the context window of the LLM 118 for each or multiple user inputs. Other data, such as the user input or conversation history data, may then be provided separately. Prompt data may be updated periodically or after each user input, and updated prompt data can be passed to the LLM 118 via the model adapter component 206.

In some examples, the bot component 204 or the model adapter component 206 is responsible for preprocessing the user message. For example, the model adapter component 206 may adjust the format of the user query or modify certain data items in the user query. In some cases, the model adapter component 206 may detect that the user query includes personally identifiable information (PII) and perform de-identification on the relevant data items before sending the prompt data to the LLM 118 (the model adapter component 206 may then re-identify the response from the generative machine learning model to the extent needed after receiving the response). In some cases, the model adapter component 206 may automatically transform the user message, or parts thereof, to reduce its overall size (e.g., perform token minimization to reduce token size).

The function invoking component 208 operates to initiate or complete actions associated with functions supported by the digital assistant. The function invoking component 208 receives function calls (e.g., an identifier of the function and its arguments) and then determines which function to invoke. For example, the LLM 118 selects a particular scenario based on the user input received, and then obtains, from the user, parameter values for a function corresponding to the selected scenario. The function invoking component 208 then handles the invocation of that function once all parameter values are available and (where applicable) confirmed by the user.

In some examples, the bot component 204 or the function invoking component 208 performs validation of function parameters prior to causing invocation of the function. As described elsewhere herein, the digital assistant service system 126 can perform parameter-level validation to check values individually, cross-validation to check sets of parameter values, or both, prior to causing invocation of the function. The bot component 204 or the function invoking component 208 can also trigger a user confirmation process where, for example, the user is explicitly asked to confirm parameter values of the function prior to performing a final function call to invoke it. In some examples, a dedicated validation and confirmation component 214 is provided to handle parameter validation or user confirmations.

The function invoking component 208 may transmit instructions to the destination connector component 210 to retrieve information from one or more destinations or to call one or more endpoints to perform actions. The function invoking component 208 may also receive outputs from one or more destinations and generate final output data to present in the user interface. In some examples, the function invoking component 208 is responsible for generating all output messages that involve business-critical functions (e.g., functions supported by the digital assistant), while other responses (e.g., non-function related conversational responses) are not generated by the function invoking component 208, as the response from the LLM 118 is used directly in such instances.

A response generated by the function invoking component 208 using, for example, an API response, can have a predefined pattern or format. For example, the LLM 118 may provide a function call for a “Get Current Weather” function (get_current_weather) which results in retrieval of a temperature and weather description for a particular city (included in the function arguments). The function invoking component 208 may then generate output data according to a predetermined pattern, such as “The temperature in [CITY] at the moment is [TEMPERATURE], and the weather is generally [DESCRIPTION].” Outputs presented to the user are stored in the conversation context 212 to ensure that the generative machine learning model has access to an up-to-date conversation history for subsequent queries.

The destination connector component 210 connects the digital assistant service system 126 to one or more backend services, such as functional modules of a business or data sources. For example, the destination connector component 210 may connect the digital assistant service system 126 to multiple business modules, such as an enterprise resource planning system, a human resources system, an account system, or a customer relationship management system. The destination connector component 210 may provide integration points to enable function calling directed at a selected destination. The function invoking component 208 or the destination connector component 210 may be responsible for selecting, for example, the correct API endpoint to call for a particular function included in a response from the LLM 118.

In some examples, at least some of the components shown in FIG. 1 or FIG. 2 are configured to communicate with each other to implement aspects described herein. One or more of the components described herein may be implemented using hardware (e.g., one or more processors of one or more machines) or a combination of hardware and software. For example, a component described herein may be implemented by a processor configured to perform the operations described herein for that component. Moreover, two or more of these components may be combined into a single component, or the functions described herein for a single component may be subdivided among multiple components. Furthermore, according to various examples, components described herein may be implemented using a single machine, database, or device, or be distributed across multiple machines, databases, or devices.

The diagram 300 of FIG. 3 diagrammatically illustrates interaction of the digital assistant service system 126 of FIG. 1 with a plurality of platforms 302, 304, 306, with the external server 114 of FIG. 1, and with a plurality of backend services 314, 316, 318, according to some examples. The platforms 302-306 shown in FIG. 3 represent different client environments from which users may interact with a digital assistant. For example, users may access the digital assistant provided by the digital assistant service system 126 using a web client 308 associated with the platform 302, using an application 310 associated with the platform 304, or using an application 312 associated with the platform 306.

The channel connector component 202 of FIG. 2 is configured to enable the digital assistant service system 126 to integrate with the different platforms 302-306. For example, the platform 302 may be a human resources management tool that has the digital assistant integrated into its web client 308, while the platform 304 is a data analytics platform that has the digital assistant integrated into its application 310, and the platform 306 is a cloud analytics ecosystem that provides a conversational AI experience through the application 312.

The digital assistant service system 126 receives user input from users accessing the platforms 302-306 and transmits responses to their respective user devices via the platforms 302-306. The digital assistant service system 126 also, in some examples, communicates with the LLM 118 hosted by the external server 114 to obtain AI-generated responses. In other examples, the digital assistant service system 126 may have an internal generative machine learning model that it uses to generate responses.

In some cases, a response generated by the LLM 118 is a direct response that is directly passed on to a user device of a user. A direct response refers, for example, to conversational content generated by the digital assistant and provided directly back to the user device of the user (e.g., the user device 106 of the user 108), without invoking execution of a function. Direct responses may include clarification questions (e.g., “I need more information from you to generate your purchase order . . . ”), notifications (e.g., “Your purchase order will be created.”), “small talk” responses (e.g., “I am well, thank you for asking. How can I help you?”), or other dialog generated based on the conversational context. Unlike function calls, direct responses do not trigger operations or retrieval of new information from external services (e.g., one of the backend services 314-318, as described below).

In other cases, the response represents a function call. The digital assistant may cause invocation of a specified function when the LLM 118 passes, for example, a function name and arguments to the model adapter component 206. This results in execution of the encapsulated capability, such as retrieval of data or performance of operations associated with the function. A function call may thus invoke external logic and access external information rather than responding based on existing conversational context.

The digital assistant service system 126 detects that the response represents a function call. For example, the model adapter component 206 of the digital assistant service system 126 detects that the response is provided in JSON format and includes a function name and arguments relating to a current scenario being handled by the external server LLM 118 (e.g., as opposed to a free-text response or simple string of data that represents a direct response). In response, the digital assistant service system 126 causes invocation of the relevant function (e.g., dialog function) by communicating with a selected one of the backend services 314-318.

The backend services 314-318 may provide capabilities and data sources leveraged by the digital assistant. For example, the backend service 314 may be associated with an enterprise resource planning system, while the backend service 316 is associated with a customer relationship management system, and the backend service 318 is associated with a billing system. Loose coupling (e.g., via APIs) may allow backend services to evolve independently, or to be dynamically changed, while still being available to be leveraged by the digital assistant service system 126.

The digital assistant service system 126 (e.g., the function invoking component 208) may access a mapping of functions to backend services (e.g., respective API endpoints) that allow the digital assistant service system 126 to request the relevant information or action from one of the backend services 314-318 in response to receiving a function call from the LLM 118. As mentioned, the function invoking component 208 may generate suitable output data based on the information retrieved or the action performed via the backend services 314-318.

FIG. 4 shows components of the conversation context 212 of FIG. 2, according to some examples. The conversation context 212 is maintained by the digital assistant service system 126 (e.g., by the bot component 204 of FIG. 2) for a digital conversation, and is shown to include model-accessible data 402 and non-model-accessible data 404.

The model-accessible data 402 is referred to as “model-accessible” since the data is included in prompts submitted to the generative machine learning model (e.g., the LLM 118 of FIG. 1). The generative machine learning model thus has direct access to the model-accessible data 402, or can process the model-accessible data 402 directly. The model-accessible data 402 includes a conversation history (e.g., message history) of a current digital conversation between the user (e.g., the user 108) and the digital assistant, and can also include details of functions (e.g., scenarios) that are selected by or available for selection by the generative machine learning model. For example, the model-accessible data 402 may indicate a currently selected scenario that the generative machine learning model is “working on,” e.g., in the process of obtaining parameter values from the user before calling the function corresponding to the scenario.

Referring to conversation history, as indicated, user input may include user messages provided by a user of the digital assistant, with the output data being generated to respond to the user message. In some examples, the prompt data provided to the generative machine learning model includes conversation history data that includes one or more earlier user messages provided by the user and earlier output data generated to respond to the one or more earlier user messages.

The conversation history data may be provided in a structured format and the prompt data may provide an indication of the structured format. The conversation history data may reflect the course of a conversation by, for example, persisting the conversation in a chronologically ordered list. For example, the list may be ordered as follows for each exchange of information: (i) user input, (ii) function call (where relevant), and (iii) output data (e.g., direct response or output based on function execution result).

In some examples, the model-accessible data 402 in the conversation context 212 is continuously updated (e.g., by the bot component 204) to include the latest user input and corresponding output data (and function information, where relevant), such that, when a user submits a follow-up or further user message, the generative machine learning model is provided with historic data that includes the latest information. For example, if a user first mentions “I'm traveling to Paris next week,” and then later mentions “What's the weather like there?” the generative machine learning model is enabled to identify that “there” refers to “Paris.” In other words, examples described herein address the natural language processing problem referred to as “co-reference resolution.”

The non-model-accessible data 404 is not directly accessible to the generative machine learning model as it is not included in the prompt data. In this way, the context size of input passed to the generative machine learning model can be reduced. In some examples, the non-model-accessible data 404 includes technical context data. As mentioned, the technical context data can include, for example, one or more of system variables, API keys, session identifiers, and other technical details that are employed for correct functioning of the system (e.g., needed for processing of user queries or requests) but are not exposed to the user (e.g., the user 108) or the generative machine learning model.

The non-model-accessible data 404 can thus obtain relatively large objects or variables, such as technical descriptions, as well as other technical details, such as API keys. It may be desirable not to pass such data to the generative machine learning model since it may have a limited context size or window. Where a context dependency exists between a function parameter and a variable in the non-model-accessible data 404, the digital assistant can obtain a value for the function parameter from the non-model-accessible data 404, avoiding the need to obtain it via the generative machine learning model or making it an optional model-obtainable parameter. This can facilitate a reduction in context size or the complexity of the generative machine learning model's tasks.

In some examples, the non-model-accessible data 404 is not “visible” to the generative machine learning model, and is also not “visible” to the user (e.g., not presented in the web interface 132 or otherwise retrievable by the user 108). Instead, the non-model-accessible data 404 is managed in the back-end, for example, by a capability developer.

FIG. 5 illustrates prompt data 502 that is provided to the generative machine learning model (e.g., the LLM 118 of FIG. 1), according to some examples. It is noted that each prompt does not necessarily include all elements depicted in FIG. 5. In other words, a prompt may include a subset of the elements depicted in FIG. 5. Furthermore, the elements depicted in FIG. 5 are not intended to be exhaustive, and other elements may be included.

As mentioned, the prompt data 502 can be submitted to the generative machine learning model via the model adapter component 206 of the digital assistant service system 126. The prompt data 502 is automatically generated and transmitted to the generative machine learning model by the digital assistant service system 126.

In some examples, a prompt that is submitted to the generative machine learning model can be referred to as a “scenario selection prompt” or a “scenario handling prompt.” This prompt is intended to guide the generative machine learning model in selecting an appropriate scenario (e.g., one or more functions supported by the digital assistant) to address a user request, and then obtaining information needed to execute the scenario. The prompt may be designed to serve as a bridge between the user's needs and the digital assistant's capabilities, ensuring that the generative machine learning model's computational power is harnessed to generate relevant and contextually appropriate outcomes.

In FIG. 5, the prompt data 502 is shown to include general definitions 504, conversation history data 506, and function data 508. The general definitions 504 include information intended to guide model behavior and response generation. For example, the general definitions 504 include a role 510 that defines the function, responsibilities, role, or capacity of the generative machine learning model within a given interaction, constraints 512 that specify limitations or rules the model is to adhere to, such as maximum response length, response format, or restricted topics, as well as a personality 514 to impart a consistent character or tone to the responses, ensuring that interactions align with the digital assistant's intended persona. The general definitions 504 may describe to the generative machine learning model how to go about invoking a function call or causing a direct response to a user, as described elsewhere.

The conversation history data 506 may include user-known context 516. For example, the user-known context 516 is the message history from the model-accessible data 402 of FIG. 4. As mentioned, technical context, such as the technical context data of the non-model-accessible data 404 of FIG. 4, is not included in the prompt data 502. The conversation history data 506 can be dynamically updated to include, for example, all user inputs and system responses up to a most recent input, or a predefined number of inputs and responses up to the most recent input, or a summary of older interactions together with the most recent inputs and responses.

The function data 508 includes a list of functions 518 that the digital assistant is capable of performing, along with function descriptions 520 that provide natural language explanations of each function's purpose and usage. The digital assistant service system 126 can dynamically select relevant functions 518 to include in the function data 508. For example, the digital assistant service system 126 can automatically select functions that are semantically similar to the user input, functions that were called or discussed in previous interaction steps (e.g., a function that is still in progress but has not been completed, since one or more parameter values are outstanding), functions that relate to a role of the user as specified in their user profile, or combinations thereof. The digital assistant service system 126 can also, where a particular function has been selected, include additional functions that have dependency relationships with the selected function to enable the generative machine learning model to leverage such function dependencies.

In some examples, the digital assistant service system 126 performs RAG to augment the prompt data 502 with relevant or potentially relevant functions selected from a larger set of available functions of the digital assistant. For instance, the digital assistant service system 126 can filter a list of 100,000 supported functions and only include the 10, 20, or 30 functions 518 identified as being relevant or potentially relevant to the current digital conversation. In this way, the overall context size can be reduced (e.g., compared to a system that includes all possible functions in the prompt data).

The function data 508 also identifies (where applicable) parameters 522 of each function. For example, the function data 508 can specify the parameters and whether they are mandatory or optional. Additionally, dependency relationships 524 are included, which represent the dependencies between functions. The dependency relationships 524 can include a graphical representation, such as a graph. The dependency relationships 524 may provide information on prerequisite and subsequent relationships to ensure the correct sequence of function execution. For example, the dependency relationships 524 indicate whether one function is a helper function for another function.

In some examples, once the user provides user input and functions 518 are selected for inclusion in the prompt data 502, the digital assistant service system 126 automatically identifies function dependencies, and dynamically generates the dependency relationships 524 (e.g., by creating triple representations of function dependencies along with a graph representation). In light of the dynamic and varied nature of user requests, in some examples, at least some of the function data 508 to be included in the prompt data 502 (e.g., the functions 518 and the dependency relationships 524) are generated in real-time by the digital assistant service system 126.

As a practical example, consider a scenario where the user is interacting with the digital assistant to troubleshoot a technical issue with a database. The digital assistant service system 126 identifies, from the user profile, that the user is a technical support staff member, and identifies from the conversation history that previous interactions have related to database issues. The digital assistant service system 126 automatically locates a set of functions that are potentially relevant to this digital conversation (e.g., using one or more of the techniques mentioned above) and includes the function data 508 for those functions, as described above, in the prompt data 502 to the generative machine learning model, together with the general definitions 504 and the conversation history data 506.

The inclusion of function dependencies in the prompt data 502 can improve the capabilities of the digital assistant. Consider, for example, the aforementioned example where a user asks a digital assistant to create a new job position within an organization. Without function dependency information, this task may be technically challenging or error-prone. This can be addressed by including, for example, the following information in the dependency relationships 524:
“Define Job Description” function (no dependency).
“Set Salary Range” function depends on “Define Job Description”
“Assign Department” function depends on “Set Salary Range”

These dependencies can be represented in triples and injected into the prompt data 502 as follows:

T = { (“define_job_description”, precedes,
“set_salary_range”),
(“set_salary_range”, precedes, “assign_department”) }

By injecting these dependency triples into the prompt data 502 along with function explanations and instructions, the generative machine learning model (e.g., the LLM 118) is informed about necessary steps and their order to fulfill the user's request to create a new job position. This structured approach helps the generative machine learning model navigate the dependencies efficiently, ensuring that the digital assistant can guide the user through the process in a logical and coherent manner. Further examples relating to function dependencies are provided below.

In some examples, the prompt data 502 may include examples to guide the LLM 118. For example, the prompt data 502 may include an example user query and an example response in the desired format and style. The prompt data 502 may also include model-specific instructions, such as model parameters for a machine learning model to apply. For example, the prompt data 502 may include LLM parameters that relate to settings or configurations of a language model, such as temperature or sampling parameters.

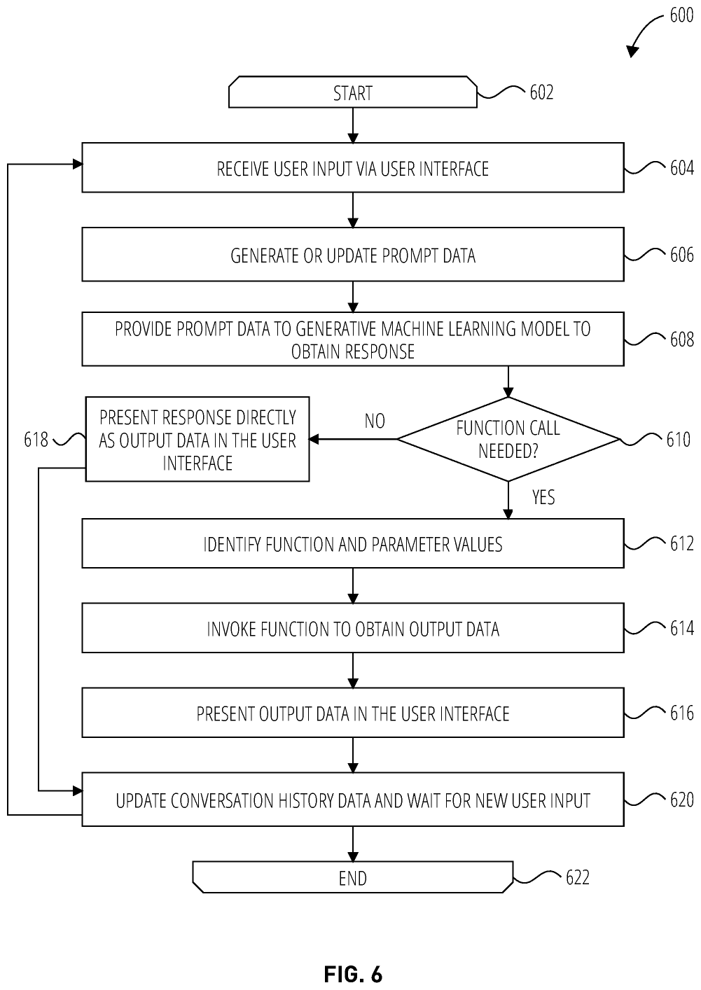

FIG. 6 is a flowchart illustrating operations of a method 600 suitable for using a generative machine learning model in a digital assistant service system, according to some examples. FIG. 6 illustrates how a digital assistant service system, such as the digital assistant service system 126 of FIG. 1, is enabled to recognize responses that trigger function calls as well as responses that should be directly presented to a user without invoking a function call.

By way of example and not limitation, aspects of the method 600 may be performed by the components, devices, systems, network, or database shown in FIG. 1 to FIG. 5. Accordingly, elements shown in one or more of FIG. 1 to FIG. 5 are referenced in the description below as non-limiting examples.

The method 600 commences at opening loop operation 602 and proceeds to operation 604, where the digital assistant service system 126 receives user input via a user interface. For example, the user 108 accesses the digital assistant via the web client 112 and submits a message or query.

At operation 606, the digital assistant service system 126 generates prompt data, such as the prompt data 502 of FIG. 5, or elements thereof. For example, the function data 508 and general definitions 504 may form a “pre-prompt” that enables the LLM 118 to adopt a distinct personality that is focused on helping the user to perform one or more functions. In addition, the prompt data can include conversation history data, such as the conversation history data 506 of FIG. 5.

The method 600 proceeds to operation 608, where the prompt data is provided to the LLM 118 to obtain a response. At decision operation 610, the digital assistant service system 126 determines whether a function call is needed. If a function call is needed (e.g., if the response from the LLM 118 contains a function identifier), the digital assistant service system 126 identifies the relevant function and the parameter values (if any) by extracting the data items from the response at operation 612. In some examples, the model adapter component 206 may parse the response to ensure correctness and to check the response type. If the digital assistant service system 126 (e.g., using the validation and confirmation component 214 of FIG. 2) validates the function arguments, for example, the digital assistant service system 126 proceeds and the function call is automatically executed.

The term “function identifier,” as used herein, refers to an identifier or mechanism used to denote that a function should be executed or invoked. For example, the function identifier may be a uniquely identifiable function name included in the response of the generative machine learning model. Alternatively or additionally, the function identifier may be a schema, format, or structure of the response (e.g., a predefined structured format that identifies the response as being intended to invoke a function). The function identifier may comprise a combination of elements, such as a function name expressed in a predefined format that accords with a given schema for function calling.

In some examples, such as when the function identifier is a function name, the function identifier indicates which function should be executed. In other examples, the response may include both the function identifier and an additional element that indicates which function should be executed.

It may be desirable, in some examples, to have all responses generated using the same structured format, with the function identifier being located within the structured format. For example, a response category type may be a key within a JSON structure and the value of that key indicates whether the response invokes a function.

The digital assistant service system 126 then uses the function invoking component 208 and the destination connector component 210 to invoke the function to obtain output data at operation 614. For example, the call may be an API call to an enterprise resource planning system that is communicatively coupled to the digital assistant service system 126 to create a sales order or some other business artifact. The output data may then include details of the created business artifact. In another example, the call may be an API call to a billing system to retrieve invoice details associated with certain criteria. The output data may then be the invoice details. The output data is presented in the user interface at operation 616.

If, at decision operation 610, the digital assistant service system 126 determines that no function call is needed (e.g., the response is merely a conversational message that does not invoke a function call due, for instance, to its unstructured format or lack of a function identifier), the response from the LLM 118 is presented directly as output data (e.g., a direct response) in the user interface at operation 618.

The digital assistant service system 126 updates the conversation history (operation 620) to include the latest interaction and waits for new or further user input. The method 600 concludes at closing loop operation 622.

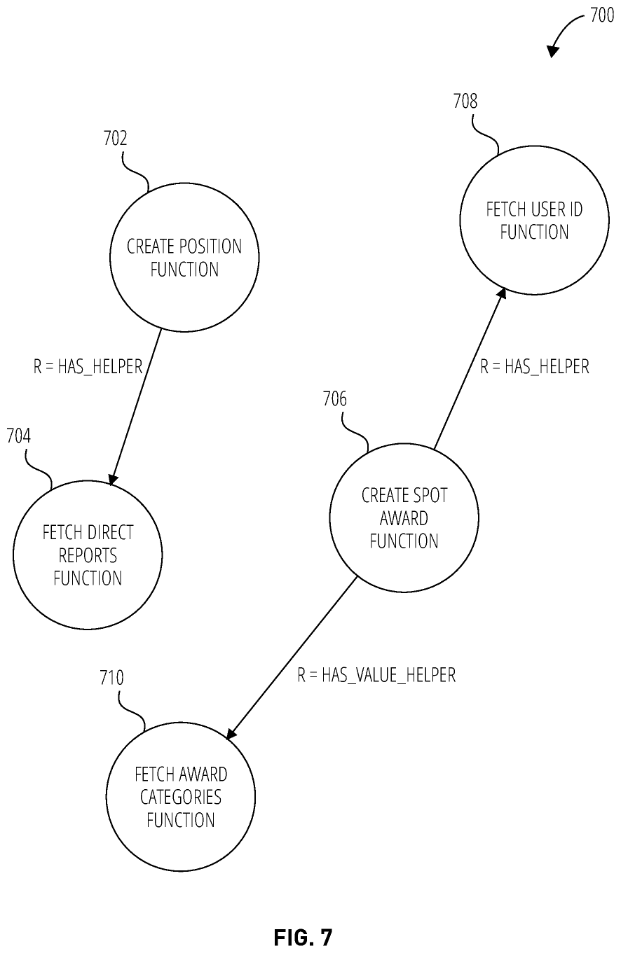

FIG. 7 is a function dependency graph 700, according to some examples. The function dependency graph 700 is an example representation of a dependency relationship data structure. In this context, a dependency relationship data structure provides an organized framework that captures and delineates dependencies or relations among functions.

The function dependency graph 700 includes several nodes representing different functions, each connected by directed edges that signify the dependencies between them. A Create Position function 702 may rely on or otherwise utilize data retrieved via a Fetch Direct Reports function 704. A Create Spot Award function 706 may rely on or otherwise utilize data retrieved via a Fetch User ID function 708 and a Fetch Award Categories function 710. For example, in order to create a spot award, a parameter value for a “user ID” parameter is needed, necessitating prior invocation of the Fetch User ID function 708.

More generally, for a function dependency graph G=(F, R), where F is a set of functions and R is a set of relations, a graph can be represented as semantic triples in the form shown below:

(f₁,r,f₂), with fᵢ∈F,r∈R

In the function dependency graph 700 of FIG. 7, R is limited to:

$$\vert R \vert = 2 , R = \{ has\_value \_helper , has\_helper \}$$

A set of semantic triples represented in the function dependency graph 700 can be thus structured as follows:

T = { (“create position”, has_helper, “fetch_direct_reports”),
(“create_spot_award”, has_helper, “fetch_user_id”),
(“create_spot_award”, has_value_helper,
“fetch_award_categories”) }

In some examples, and as shown above and in FIG. 7, two types of helper functions are defined. A first type, indicated by the relation “has_helper,” refers to a helper function that can also act as a standalone function. For example, the user may wish to execute only the Fetch Direct Reports function 704 independently from the Create Position function 702. A second type, indicated by the relation “has_value_helper,” refers to a helper function that is not intended to be used as a standalone function. For example, the Fetch Award Categories function 710 would typically only be used to obtain the categories for purposes of ultimately invoking the Create Spot Award function 706.

The triples define relationships in a format that is interpretable by a generative machine learning model (e.g., the LLM 118). For instance, when a user initiates a request to create a spot award, the generative machine learning model receives the request together with function data that includes the triples. Guided by the dependencies and other prompt data, the generative machine learning model understands that the Fetch User ID function 708 and the Fetch Award Categories function 710 would first need to be invoked before the Create Spot Award function 706 can be invoked, since values obtained via the Fetch User ID function 708 and the Fetch Award Categories function 710 can be used as arguments in the Create Spot Award function 706. The generative machine learning model then proceeds to invoke the prerequisite functions and, where needed, generates output in which the user is asked to provide parameter values.

In some examples, the function data 508 injected into the prompt data 502 includes the dependency relationships 524 in triple format, and further includes a brief explanation of the graph/triple structure and an instruction to follow the function dependencies as modeled. Such further information and instructions may alternatively form part of the general definitions 504 in the prompt data 502.

The function dependencies can enable the generative machine learning model to understand entry points for execution of certain workflows or scenarios. For example, and as touched on above with respect to standalone functions, a node that only has one or more incoming “has_value_helper” relation typically cannot be selected by the generative machine learning model as an entry point. An instruction to adhere to one or more entry points defined by the dependency relationship data structure can be explicitly included in the prompt data 502.

In some examples, relations between functions are stored and updated as supported functions are added or removed from the digital assistant service system 126 (e.g., in the database 130 of FIG. 1), allowing for dynamic generation of triple representations once a set of functions has been identified for a particular digital conversation or user interaction. Since an enterprise-scale digital assistant may support a large number of functions, efficiency can be enhanced by generating only the relevant dependency information “on-the-fly” and passing the information to the generative machine learning model.

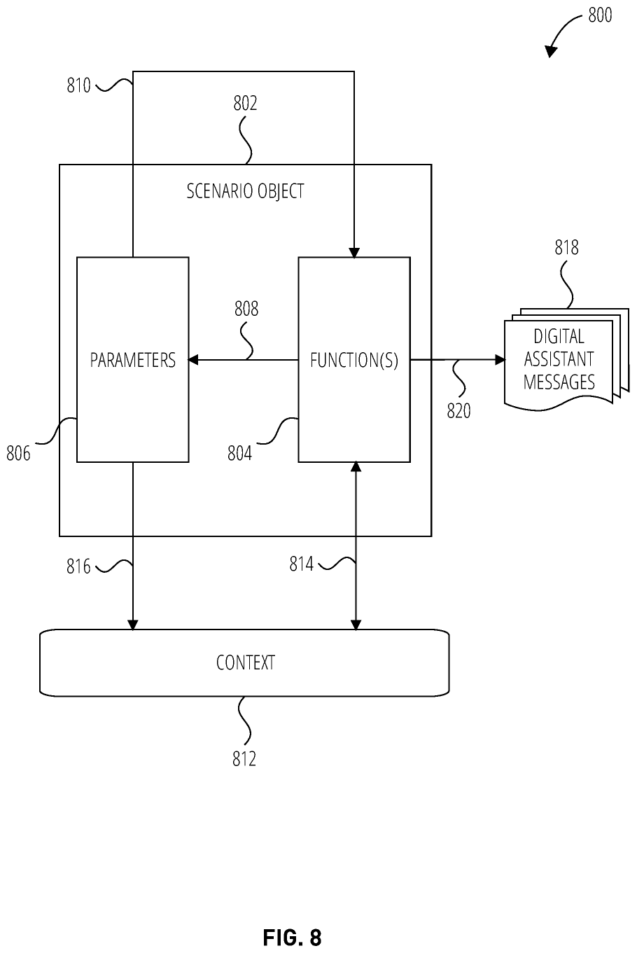

To support complex or relatively complex scenarios, functions can define dependencies to other functions in the form of mandatory parameters. If the value for such a parameter is not yet known or available, a dependent or related function of a targeted function can be executed to determine the value. As the dependent or related function can itself define dependencies, a tree-like structure may be created, with the originally targeted function only being called by the digital assistant service system 126 once dependencies are fulfilled. This approach is conceptually illustrated in FIG. 8, which shows a diagram 800 of these interdependencies.

For example, to execute a scenario associated with a scenario object 802 in FIG. 8, one or more function(s) 804 (e.g., one or more dialog functions of the digital assistant service system 126) are to be invoked. Each function(s) 804 has parameters 806 and the parameter values are needed before the function(s) 804 can be invoked by the digital assistant service system 126, as indicated by the arrow 808.

In some cases, parameter values can be obtained via dependent or related function(s) 804 based on function dependencies, as indicated by the arrow 810, creating a structure in which dependencies are to be resolved prior to invoking an originally targeted function. In some cases, parameter values can be obtained from context 812 of the digital conversation, as indicated by the arrow 816. For example, a parameter may have a context dependency to a variable within the technical context data that is part of the non-model-accessible data 404 of FIG. 4.

For example, the generative machine learning model can identify a target function that has six parameters. One parameter can be provided via the technical context and is thus optional from the generative machine learning model's perspective (e.g., it is available via the non-model-accessible data in the context 812). Two further parameters are obtained by calling a related function. The three remaining parameters are obtained from the user input to the digital assistant (e.g., also available in the context 812, but in the model-accessible data thereof).

Accordingly, it is possible for a parameter to have zero, one, or two types of dependencies. A parameter can have zero dependencies if, for example, it can only be obtained from the user via user input and is not available via the context 812 or triggering of a dependent function. A parameter can have one type of dependency if it has a function dependency or a context dependency. A parameter can have two types of dependencies if it has a function dependency (e.g., it can be obtained by invoking a dependent or related function) as well as a context dependency (e.g., it can also be obtained from the technical context data). In some examples, a value can be obtained from the context 812 by the digital assistant service system 126, but subsequently overridden by user input or a function call.

In some cases, the value is obtained from the context 812 by the digital assistant service system 126 if the digital assistant service system 126 detects a context dependency and determines that it was not obtained via user input or a function call. In some cases, for a parameter with both a context dependency and a function dependency, the digital assistant service system 126 automatically calls the related function in response to determining that a relevant value could not be retrieved via the context dependency.

In some examples, the context 812 is continuously updated to enable the digital assistant service system 126 to determine whether parameter values have been obtained or changed (see the arrow 814). The invocation of the function(s) 804 can lead to one or more digital assistant messages 818, as is also shown in FIG. 8 (see arrow 820).

For example, the scenario object 802 might represent a process of creating a new job position in an organization, as described above. Before the “Set Salary Range” function can be invoked, the digital assistant service system 126 needs to invoke the “Define Job Description” function, which provides one or more outputs that are inputs to the “Set Salary Range” function. The “Set Salary Range” function in turn provides one or more outputs that are inputs to the “Assign Department” function. By providing function data to the generative machine learning model according to this approach, the digital assistant service system 126 can ensure that all necessary data is collected and validated, allowing the digital assistant to handle complex scenarios with multiple interdependent steps. Furthermore, the digital assistant service system 126 may obtain at least a subset of the information from the context 812 (e.g., from the technical context data that is not “visible” to the generative machine learning model) via context dependencies.

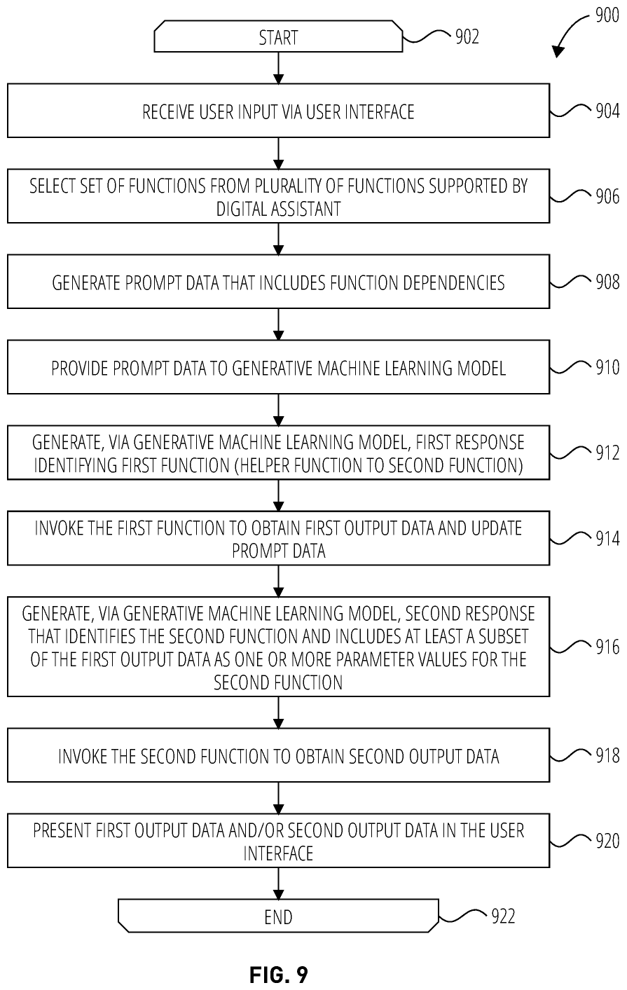

FIG. 9 is a flowchart illustrating operations of a method 900 suitable for using a generative machine learning model in a digital assistant service system, according to some examples. FIG. 9 illustrates how a digital assistant service system, such as the digital assistant service system 126 of FIG. 1, is enabled to leverage function data that includes function dependencies.

By way of example and not limitation, aspects of the method 900 may be performed by the components, devices, systems, network, or database shown in FIG. 1 to FIG. 5. Accordingly, elements shown in one or more of FIG. 1 to FIG. 5 are referenced in the description below as non-limiting examples.

The method 900 commences at opening loop operation 902 and proceeds to operation 904, where the digital assistant service system 126 receives user input via a user interface. For example, the user 108 accesses the digital assistant via the web client 112 and submits a message or query.

At operation 906, the digital assistant service system 126 selects a set of functions from a plurality of functions supported by the digital assistant. Various techniques may be used to select functions. The functions can be selected, for example, based on the user input submitted by the user, based on a user profile of the user, based on previous interactions, based on dependencies between functions, or combinations thereof. In some examples, RAG techniques are implemented by the digital assistant service system 126 (e.g., by the bot component 204 of FIG. 2).

RAG is a technique that combines the capabilities of a retrieval system with a generative machine learning model. In the context of digital assistants, RAG can be employed to preselect relevant functions by retrieving a subset of information from a large database or knowledge base that is pertinent to the user's query or context (e.g., functions that relate to a conversation topic or are semantically similar to a query based on vector similarity). The retrieval acts as a filtering mechanism, narrowing down the potential functions that the generative machine learning model should consider. For instance, if a user asks about retrieving a list of employees, the digital assistant service system 126 might retrieve, from the database 130 of FIG. 1, functions related to data aggregation, human resources, and report generation, while omitting unrelated functions such as financial, scheduling, or email management functions. The RAG approach ensures that the generative machine learning model, including its context window, is not overwhelmed by the full scope of available functions, which can lead to inefficiencies, irrelevant suggestions, higher computing costs, or insufficient context availability.

At operation 908, the digital assistant service system 126 generates prompt data. For example, the prompt data 502 of FIG. 5, or parts thereof, can be generated. The prompt data includes the functions retrieved at operation 906 and identifies dependencies between the functions. In the case of FIG. 9, the prompt data identifies at least a first function and a second function. The first function is a helper function in relation to the second function. The method 900 proceeds to operation 910, where the prompt data is provided to the generative machine learning model (e.g., the LLM 118).

In the method 900 of FIG. 9, the generative machine learning model processes the prompt data and generates a first response at operation 912. The first response identifies a first function. For example, the generative machine learning model determines that the user wishes to perform the second function, but that, based on a dependency relationship data structure in the prompt data, the first function is to be invoked prior to invoking the second function.

Accordingly, the first response may include a function identifier of the first function and one or more parameter values needed to invoke the first function. As explained elsewhere, parameter values can be obtained from the user, from non-model-accessible data (e.g., technical context data) by the bot component 204 or the model adapter component 206, or by calling related functions.

The digital assistant service system 126 identifies the first response as a first function call. The digital assistant service system 126 then invokes the first function (e.g., via the function invoking component 208) to obtain first output data at operation 914. The digital assistant service system 126 also updates the prompt data to include the first output data (e.g., the result or output of the first function) to enable the generative machine learning model to process the first output data and generate further responses based on the latest information.

The generative machine learning model generates a second response at operation 916. Specifically, the generative machine learning model utilizes at least a subset of the first output data as input (e.g., one or more parameter values) for the second function that the user wishes to have invoked. For example, where the second function has, as a mandatory parameter, a store ID, and the user mentioned the store name in the user input when asking about the list of employees, the generative machine learning model uses the first function to retrieve the store ID for the mentioned store. This enables the generative machine learning model to use the store ID parameter value to create a function call for the second function.

Accordingly, the second response may include a function identifier of the second function and one or more parameter values needed to invoke the second function. The digital assistant service system 126 identifies the second response as a second function call. The digital assistant service system 126 then invokes the second function (e.g., via the function invoking component 208) to obtain second output data at operation 918. The digital assistant service system 126 may utilize action groups defined for functions (as described elsewhere) to trigger function calls and present output to the user.

At operation 920, the digital assistant service system 126 causes presentation of the first output data or the second output data, or both, in the user interface of the digital assistant (e.g., in the web interface 132 or the app interface 134 of FIG. 1). For example, where the user requested a list of employees of the aforementioned store, the second output data includes the request list, which is then presented to the user in the web interface 132. The method 900 concludes at closing loop operation 922. Aspects of the method 900 may thus be utilized within the digital assistant service system 126 to ensure efficient “filling” of parameter values for functions based on function dependencies. The efficiency can be enhanced by leveraging the technical context of the digital conversation (e.g., in the non-model-accessible data 404 of FIG. 4).

It is noted that while the description of the method 900 of FIG. 9 only involves one dependency, multiple dependencies can be utilized by the digital assistant service system 126 in other examples, and such dependencies can span across more than two functions. For instance, in another example of the method 900, the function data might identify dependencies between the first function, the second function, and a third function. Where the second function has, as mandatory parameters, both a store ID and a country ID, the generative machine learning model might use the first function to retrieve the store ID for the mentioned store and separately use the third function to retrieve the country ID (based on an indication, in the function data, that the third function is another helper function that can be used to retrieve the country ID). In such a case, after the first function and the third function have been invoked to obtain the mandatory parameter values for the second function, the method 900 would proceed to operation 916 to generate a response that identifies the second function and its mandatory parameter values, after which the second function is then invoked at operation 918.

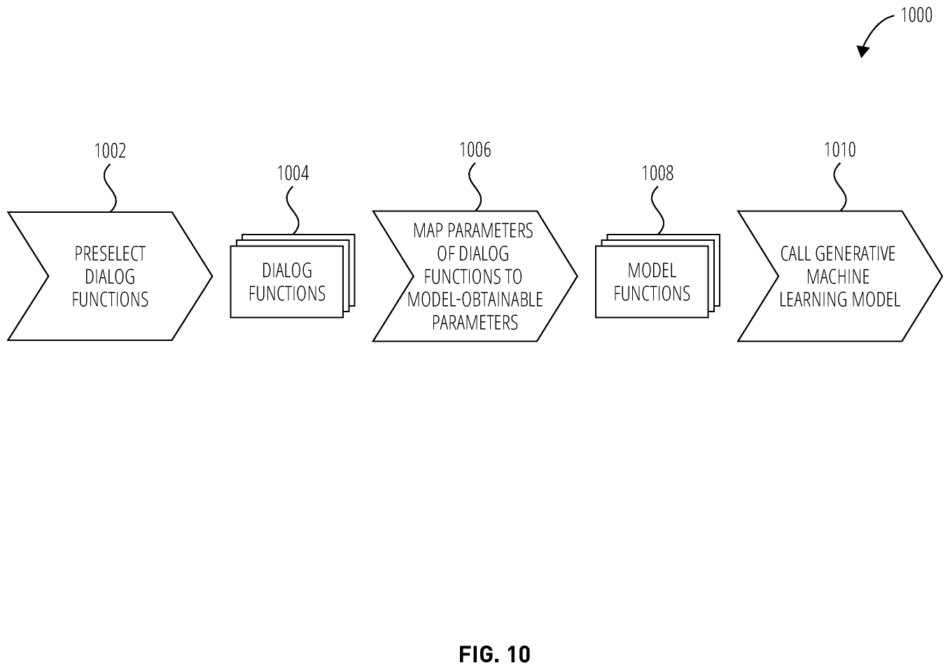

As mentioned, in some examples, parameters of functions invoked and managed by the digital assistant outside of the context of the generative machine learning model (such functions can be referred to as “dialog functions”) are mapped to parameters of scenarios to be handled by the generative machine learning model within its context (such parameters can be referred to as “model-obtainable parameters”). FIG. 10 illustrates a process 1000 for mapping dialog function parameters to model-obtainable parameters, according to some examples.

The process 1000 starts with operation 1002, where the digital assistant service system 126 preselects a set of dialog functions 1004. For example, the digital assistant service system 126 analyzes the user query and uses RAG techniques to preselect the dialog functions 1004 that are relevant or potentially relevant to the current digital conversation for inclusion in the prompt data.

In the example of FIG. 10, the dialog functions 1004 are selected based on a role of the user within an organization (indicated in their user profile) and vector similarities between input messages and supported functions. Furthermore, where the database 130 of FIG. 1 (that stores function data) indicates that a selected function has dependent or related functions, such dependent or related functions are also included.

The dialog functions 1004 can each include a number of data items. In the example of FIG. 10, a dialog function may have one or more parameters and context dependencies for one or more of the parameters. For example, a capability developer can define a context path that can be used to obtain a parameter value. Furthermore, the capability developer can define function dependencies of the dialog function.

A dialog function can also include one or more action groups. In this context, an “action group” may include a collection of actions or tasks that are logically grouped together to achieve a specific outcome in response to a user's request or as part of a scenario execution. An action group may be defined by a set of conditions and the corresponding actions that should be taken when those conditions are met. These actions can include invoking dialog functions, sending messages, making API calls, setting variables, validating parameters, performing explicit parameter confirmation operations, or the like. In some examples, action groups are handled by the digital assistant service system 126 outside of the context of the generative machine learning model. For example, the LLM 118 provides information or output that the digital assistant uses to determine which action groups to activate, but the actual execution of these groups is independent of the LLM 118.

At operation 1006, the dialog functions 1004 are transformed to model functions 1008. During operation 1006, a structured representation of each of the dialog functions 1004 is generated by the digital assistant service system 126, including its name, description, and parameters. The name of a model function may be the same or different than its corresponding dialog function's name. Where the names are different, the digital assistant service system 126 stores a mapping to ensure that the model function can be mapped back to the dialog function after receiving generative machine learning model responses.

The mapping performed in operation 1006 takes into account any context dependencies and function dependencies that exist for each of the dialog functions 1004. For example, to obtain a model function that corresponds to a particular dialog function, each parameter of the dialog function is mapped to a corresponding parameter of the model function (e.g., a model-obtainable parameter). In some examples, the digital assistant service system 126 creates a one-to-one mapping on the parameter level, with each parameter of the dialog function having a corresponding model-obtainable parameter in its corresponding model function.

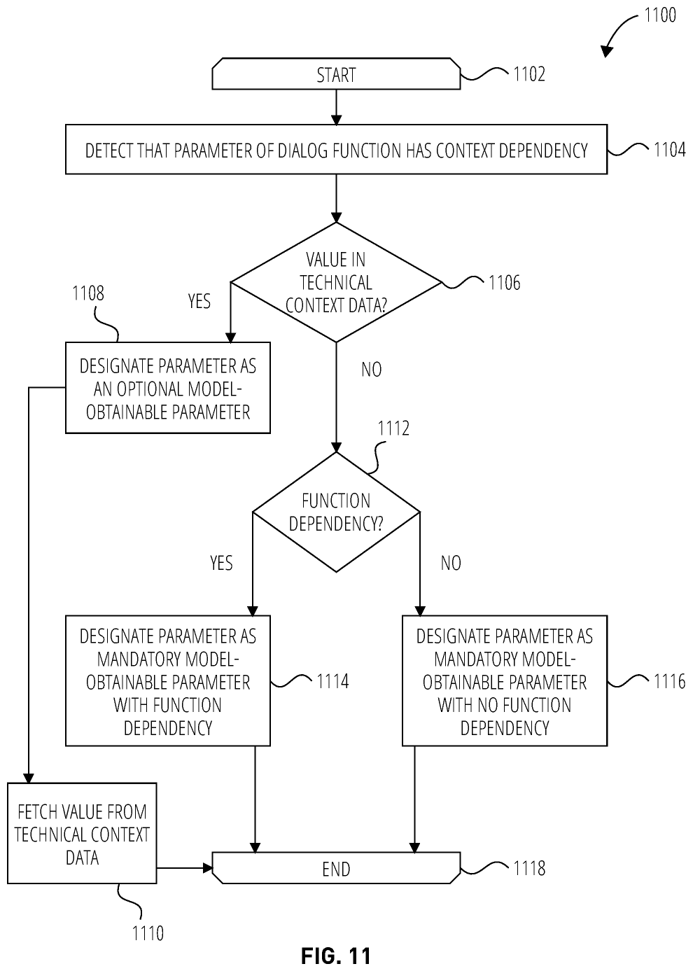

In some examples, the digital assistant service system 126 determines whether each parameter should be designated as optional or mandatory in the model function, for example, based on context dependencies, function dependencies, or prior user input. Accordingly, where context dependencies exist, a parameter that is mandatory in one of the dialog functions 1004 can be optional in its corresponding one of the model functions 1008. This is described in greater detail with reference to FIG. 11.

The model functions 1008 are the functions corresponding to respective dialog functions 1004 as represented in a format and structure that the generative machine learning model (e.g., the LLM 118) can understand, process, and retrieve values for. The process 1000 then proceeds to operation 1010, where the generative machine learning model is called with the prompt data that includes the model functions 1008 (e.g., along with other prompt data of the prompt data 502 of FIG. 5). This allows the generative machine learning model to evaluate the functions in the context of the user's input and the ongoing conversation. The generative machine learning model can select appropriate functions to execute in order to fulfill a user request.

The digital assistant service system 126 understands the mapping between the dialog functions 1004 and their corresponding model functions 1008. Thus, when the generative machine learning model generates a response that is intended to invoke a function, and the response identifies one of the model functions 1008, the digital assistant service system 126 can automatically invoke the corresponding dialog functions 1004 via the function invoking component 208 of FIG. 2.

The digital assistant service system 126 can designate a parameter of a dialog function as a mandatory model-obtainable parameter if it must be obtained via the generative machine learning model for the function to be executed, or as an optional model-obtainable parameter if it can be obtained without using the generative machine learning model (or if it is simply an optional argument that is not needed by the function invoking component 208 of FIG. 2). FIG. 11 is a flowchart illustrating operations of a method 1100 suitable for obtaining or classifying parameters during generation of prompt data in a digital assistant service system, according to some examples.

By way of example and not limitation, aspects of the method 1100 may be performed by the components, devices, systems, network, or database shown in FIG. 1 to FIG. 5. Accordingly, elements shown in one or more of FIG. 1 to FIG. 5 are referenced in the description below as non-limiting examples. The method 1100 may be performed by the digital assistant service system 126 as part of operation 1006 of the process 1000 of FIG. 10.

The method 1100 commences at opening loop operation 1102 and proceeds to operation 1104, where the digital assistant service system 126 detects that a parameter of a dialog function has a context dependency. At decision operation 1106, the digital assistant service system 126 then checks whether a value for the parameter is available by accessing technical context data (e.g., in the non-model-accessible data 404 of FIG. 4).

If the digital assistant service system 126 determines that the value can be retrieved, the digital assistant service system 126 designates the parameter as an optional model-obtainable parameter at operation 1108. In other words, the digital assistant service system 126 indicates, in the function data passed to the generative machine learning model, that the relevant parameter is optional for purposes of the generative machine learning model's task. After operation 1108, the digital assistant service system 126 fetches the relevant value from the technical context data at operation 1110 (e.g., without using the generative machine learning model). In some examples, the fetched value can be overridden by user input or through the calling of a related function. In some examples, if a parameter is expected to be present in the context, a capability developer designing a dialog function can specify a context path to a context variable together with an optional dependency to a function providing the variable (e.g., helper function).

If the digital assistant service system 126 determines, at decision operation 1106, that the value cannot be retrieved from the technical context data, the parameter will be a mandatory model-obtainable parameter, and the method 1100 proceeds to decision operation 1112, where the digital assistant service system 126 checks whether the parameter has any function dependencies. For example, the digital assistant service system 126 checks a dependency relationship data structure to determine whether the parameter value could be obtained by calling a helper function.

If the digital assistant service system 126 determines, at decision operation 1112, that a relevant function dependency exists, the parameter is designated by the digital assistant service system 126 (e.g., in the function data passed to the generative machine learning model) as a mandatory model-obtainable parameter with a function dependency (operation 1114). In this way, the digital assistant service system 126 indicates, to the generative machine learning model, (a) that the parameter is mandatory, and (b) that it can be obtained by calling a helper function (or, in some cases, by calling the helper function or obtaining the value from the user). For example, the function data can indicate to the generative machine learning model to first select the helper function before selecting the target function.

If the digital assistant service system 126 determines, at decision operation 1112, that no relevant function dependency exists, the digital assistant service system 126 designates the parameter as a mandatory model-obtainable parameter with no function dependency at operation 1116 (e.g., in the function data passed to the generative machine learning model). This indicates, to the generative machine learning model, (a) that the parameter is mandatory, (b) that there is no related function that can be called to retrieve the parameter value, meaning that the generative machine learning model should request it from the user or find it in the latest conversation history.

Operations in the method 1100 can be automatically performed by the digital assistant service system 126 to translate parameters of a dialog function (e.g., one of the dialog functions 1004 of FIG. 10) to corresponding parameters of a model function (e.g., one of the model functions 1008 of FIG. 10). The operations may be repeated for multiple parameters. The method 1100 concludes at closing loop operation 1118.

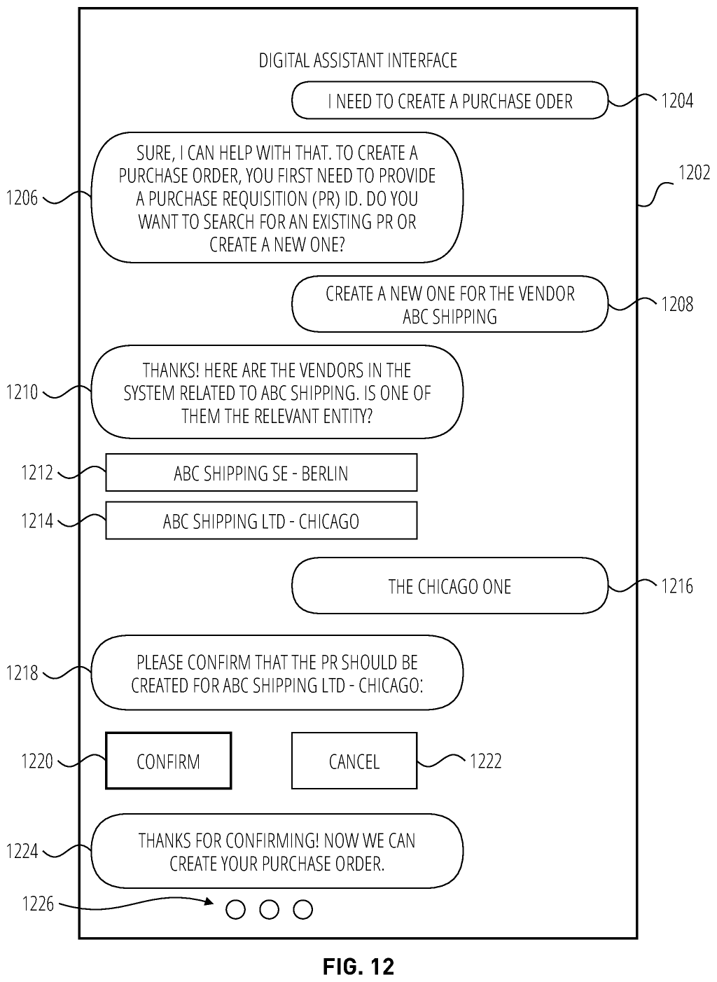

FIG. 12 is a user interface diagram illustrating a digital assistant interface 1202, according to some examples. The digital assistant interface 1202 can, for example, be displayed on a display of the user device 106 of FIG. 1 (e.g., via the web client 112). However, the digital assistant interface 1202 may be presented in various other ways (e.g., within a dedicated mobile application) and on various types of devices. Messages may also be conveyed or exchanged using other modalities, such as audio.

The digital assistant interface 1202 is associated with a digital assistant (e.g., provided by the digital assistant service system 126 of FIG. 1) that leverages a generative machine learning model (e.g., the LLM 118 of FIG. 1), as described in various examples herein. FIG. 12 illustrates how the digital assistant is enabled to leverage function data that includes function dependencies (e.g., represented using semantic triples), and resolve a dependency flow without explicit conversation design.

The user submits a first message 1204 that indicates that the user wishes to create a purchase order. The first message 1204 is passed to the generative machine learning model together with other prompt data (e.g., the prompt data 502 of FIG. 5). The prompt data is processed by the generative machine learning model. The generative machine learning model identifies that the first message 1204 relates to a target function (e.g., a “Create Purchase Order” function), but that the digital assistant service system 126 does not have all the required parameter values needed to generate the function call for the target function.

In the case of FIG. 12, the generative machine learning model identifies that a purchase requisition ID (“PR ID”) is a mandatory parameter needed to trigger the target function, and that two possible helper functions can be used to obtain the PR ID. One helper function related to the target function creates a new PR ID, and another helper function related to the target function searches for or retrieves an existing PR ID.

In other words, based on the function dependencies in the function data, the generative machine learning model automatically identifies that a helper function can be used to obtain a parameter value for the target function. However, the helper functions also have parameters that need to be obtained. Accordingly, instead of a function call, the generative machine learning model generates a direct response in the example form of a first response 1206. The first response 1206 indicates the information required from the user in order to assist with the request.

The user submits a second message 1208 which provides some information that identifies a relevant helper function for obtaining the PR ID (e.g., a “Create Purchase Requisition” function), but does not provide the exact information needed to trigger this helper function. Specifically, the second message 1208 does not identify an existing vendor ID to be used as an argument in the helper function.

The generative machine learning model is able to understand the relevant instructing part of the second message 1208 (“create a new one”), and also understands that it should identify the specific entity associated with “the vendor ABC Shipping.” Specifically, based on another dependency, the generative machine learning model understands that a vendor name can provide the required vendor ID. In other words, the generative machine learning model identifies another helper function—not for the original target function, but for the helper function used to create the PR ID.

The generative machine learning model provides a function call to return entity names related to “ABC Shipping.” The digital assistant service system 126 (e.g., the model adapter component 206) identifies the function call for resolving the entity name and invokes the relevant function. The function call returns entities “ABC Shipping SE-Berlin” and “ABC Shipping Ltd-Chicago,” and these details are added to the prompt data for the generative machine learning model to process. The generative machine learning model then generates another direct message in the form of a second response 1210, asking the user to confirm information needed for the helper function for obtaining the PR ID (e.g., for the “Create Purchase Requisition” function) by selecting either user-selectable element 1212 or user-selectable element 1214. The user responds with a third message 1216 indicating “The Chicago one,” which the generative machine learning model correctly interprets as a selection of user-selectable element 1214 (“ABC Shipping Ltd-Chicago”).

This provides the generative machine learning model with the correct name of the vendor. The generative machine learning model then triggers a further function call for the helper function used to get the vendor ID.

Once the vendor ID has been obtained, the generative machine learning model possesses all inputs needed to trigger the helper function for creating the PR ID. The digital assistant then provides a third response 1218 that asks the user to confirm the details for creating the PR ID by selecting a user-selectable element 1220. The user can also cancel the process by selecting a user-selectable element 1222 in the digital assistant interface 1202. In this case, the user selects the user-selectable element 1220 corresponding to “Confirm.”

The generative machine learning model then uses the selection of the user to craft a function call for the helper function for obtaining the PR ID (e.g., a “Create Purchase Requisition” function). The digital assistant service system 126 (e.g., the model adapter component 206) identifies the function call for obtaining the PR ID and invokes the helper function (e.g., via the function invoking component 208). This returns the PR ID, and the PR ID is added to the prompt data that is accessible to the generative machine learning model. The digital assistant service system 126 can then proceed to execute the original target function using the PR ID parameter value obtained via the helper function, as indicated by a fourth response 1224 and dots 1226 shown in FIG. 12.

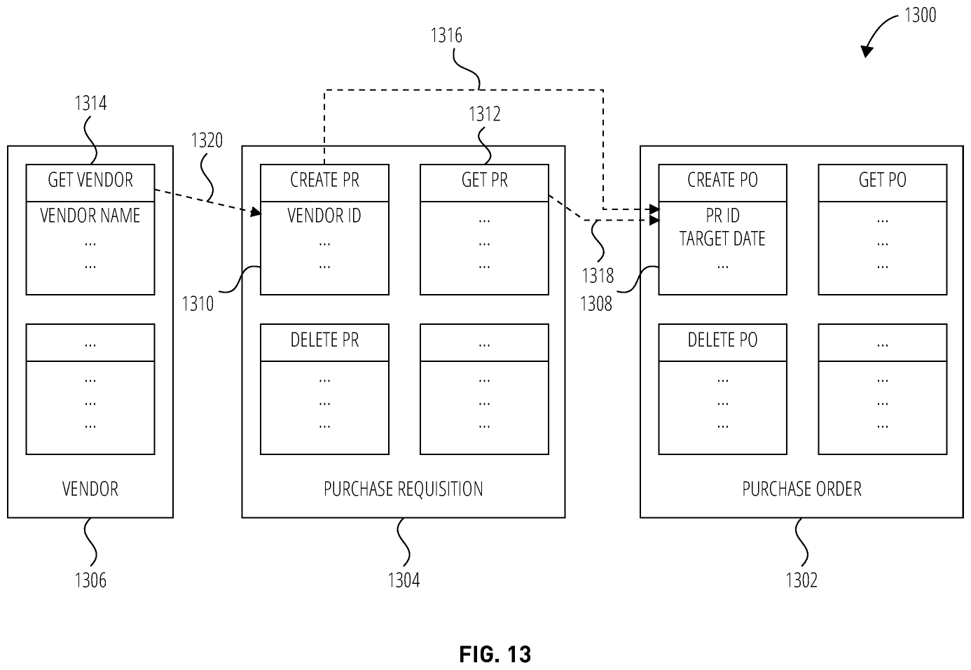

FIG. 13 is a function data diagram 1300 that illustrates function dependencies described in the discussion of FIG. 12. FIG. 13 outlines a workflow and dependencies involved in the process of creating a purchase order and a purchase requisition within a digital assistant service system, such as the digital assistant service system 126.

The function data (e.g., the function data 508 of FIG. 5) included within the prompt data (e.g., the prompt data 502 of FIG. 5) defines purchase order functions 1302, purchase requisition functions 1304, and vendor functions 1306, and also indicates dependencies between them (e.g., using triple representations as part of the dependency relationships 524 of FIG. 5).

One of the purchase order functions 1302 is a Create Purchase Order function 1308. This function is responsible for generating a new purchase order within a system supported by the digital assistant service system 126. However, PR ID is a mandatory parameter of the Create Purchase Order function 1308, so before a purchase order can be created, a purchase requisition must exist. To obtain a PR ID, a Create Purchase Requisition function 1310 of the purchase requisition functions 1304 can be called to create a new one (as indicated by the dependency 1316), or an existing PR ID can be retrieved using a get PR ID function 1312 of the purchase requisition functions 1304 (as indicated by the dependency 1318).

Furthermore, to use the Create Purchase Requisition function 1310, a vendor ID is needed. A Get Vendor function 1314 of the vendor functions 1306 can be invoked to return a vendor ID corresponding to a particular vendor name. This is illustrated by the dependency 1320 in FIG. 13.

The generative machine learning model can leverage the function data and dependencies as shown in the function data diagram 1300 of FIG. 13 to manage a conversation flow and dependencies without access to an explicitly modeled workflow. This provides more flexibility and lowers development effort, enabling digital assistants to be more easily deployed at scale, while also providing benefits of generative AI, such as human-like, diverse, or creative language.

Referring back to FIG. 12, the generative machine learning model identifies that the Create Purchase Order function 1308 is to be invoked to address the user's query as expressed in the first message 1204. The generative machine learning model then leverages the various function dependencies to (a) identify that the Create Purchase Requisition function 1310 is to be invoked as a helper function, (b) identify that the Get Vendor function 1314 is to be invoked as a further helper function, (c) get the vendor ID associated with the vendor “ABC Shipping Ltd-Chicago” via the Get Vendor function 1314, (d) use the vendor ID to trigger the Create Purchase Requisition function 1310 to obtain the PR ID, and (c) finally use the PR ID to trigger the originally targeted function, which is the Create Purchase Order function 1308, to create the purchase order. In this way, the digital assistant leverages the generative machine learning model to automatically identify and navigate a tree-like structure to resolve dependencies.

It will be appreciated that FIG. 13 provides a simplified illustration, and only shows certain parameters. Other parameters may be resolved in various ways, such as by obtaining user input (e.g., the user specifies the “target date” for the Create Purchase Order function 1308) or by following a context path of a context dependency of a parameter (e.g., the “target date” is resolved via the technical context data in the non-model-accessible data 404 of FIG. 4).

In some examples, parameter values, such as parameter values input by the user or provided by the generative machine learning model for triggering a dialog function, are validated by the digital assistant service system 126 to ensure that they are correct prior to invoking the relevant function. As mentioned, the digital assistant service system 126 of FIG. 2 can include a validation and confirmation component 214 configured for this purpose. In some examples, parameters are validated by the digital assistant service system 126 on a parameter level (e.g., an individual parameter is validated on its own). Alternatively, or additionally, parameters can be validated together (e.g., through cross-validation) by the digital assistant service system 126 to ensure that a set of parameter values is correct.

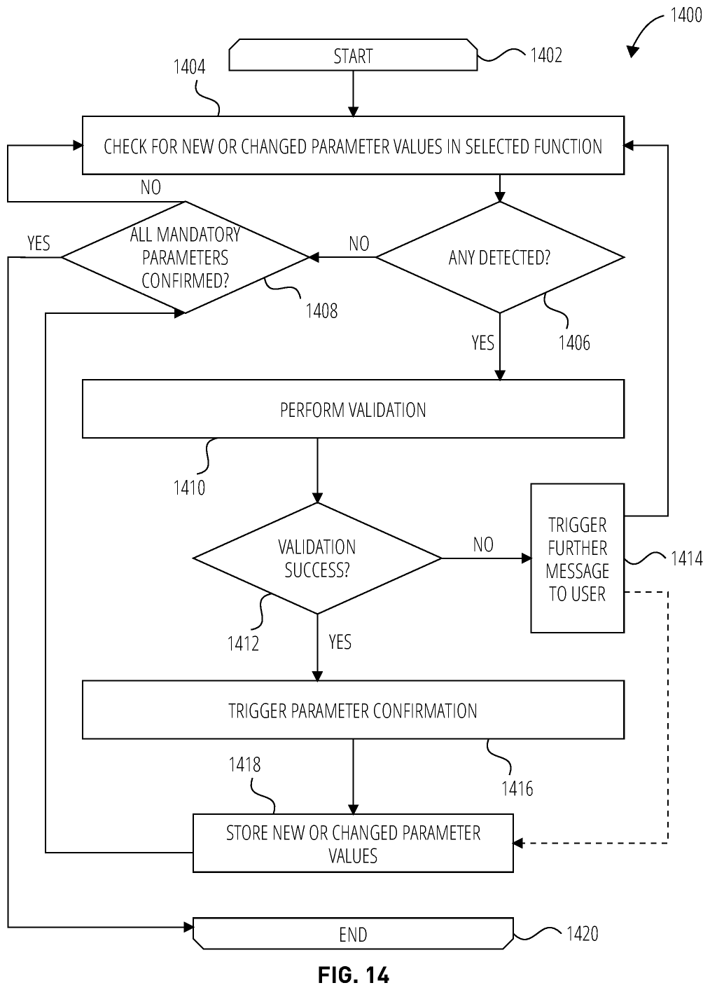

FIG. 14 is a flowchart illustrating operations of a method 1400 suitable for performing dynamic parameter validation in a digital assistant service system (e.g., the digital assistant service system 126 of FIG. 1), according to some examples. By way of example and not limitation, aspects of the method 1400 may be performed by the components, devices, systems, network, or database shown in FIG. 1 to FIG. 5, such as the validation and confirmation component 214. Accordingly, elements shown in one or more of FIG. 1 to FIG. 5 are referenced in the description below as non-limiting examples.

The method 1400 commences at opening loop operation 1402, and proceeds to operation 1404 where the digital assistant service system 126 checks a conversation context (e.g., the conversation context 212) for any new or changed parameter values relating to a selected function (e.g., a scenario that was selected by the LLM 118 and for which parameter values are being obtained).

Referring to decision operation 1406, if the digital assistant service system 126 detects a new or changed parameter value, the method 1400 proceeds to operation 1410, where the digital assistant service system 126 (e.g., the validation and confirmation component 214) performs parameter validation.

Various validation operations can be performed. For example, the digital assistant service system 126 can check whether a provided value meets one or more criteria, such as matching a value or its format with a value or format in the database 130. It will be appreciated that validation criteria can depend on the parameter type, the function type, or the preferences of a developer. Validation criteria can range from simple checks to confirm that input matches a required format (e.g., a day/month/year convention) to more complex checks, such as cross-validation of interrelated parameter values based on a stored validation formula.

In some cases, parameter validation can be performed at the parameter level, and it is thus not necessary for multiple or all parameters to have been provided prior to commencing operation 1410. In this way, validation can be performed dynamically (e.g., as a user provides new values or changes values in the user interface) to provide the user with an early warning should any issues be detected. In other words, in some examples, the digital assistant service system 126 does not wait until all values have been provided before performing validation.

If operation 1410 is not successful and one or more parameters cannot be validated, the method 1400 moves from decision operation 1412 to operation 1414, where the digital assistant service system 126 triggers a further message to the user. For example, the validation and confirmation component 214 or the model adapter component 206 can transmit a notification of the validation failure to the generative machine learning model (e.g., the LLM 118) by way of additional prompt data. The generative machine learning model receives the additional prompt data detailing the validation failure (e.g., together with an instruction to notify the user of the failure) and generates a response. The response provides a user-directed message related to the failed validation that is then presented to the user via the digital assistant.

For example, the user receives a message notifying them of the parameter that could not be validated, and explaining that the value needs to be changed or corrected before the digital assistant can proceed. In this way, the natural language capabilities of the generative machine learning model can be further leveraged to assist the user in troubleshooting a validation issue.

After triggering the further message at operation 1414, the method 1400 proceeds back to operation 1404. Furthermore, in some examples, after triggering the further message at operation 1414, the digital assistant service system 126 can also perform operation 1418 (as indicated by the broken line in FIG. 14). In addition to storing new or changed parameter values at operation 1418, the digital assistant service system 126 can also store an indication of a failed validation for future reference (e.g., in case the user does not correct the value).

In some examples, if operation 1410 is successful and the one or more parameters in question are validated, the method 1400 moves from decision operation 1412 to operation 1416, where the digital assistant service system 126 triggers parameter confirmation. Parameter confirmation may involve obtaining, by the digital assistant service system 126 and via the user device 106 of the user, explicit user approval of one or more parameter values of the function, prior to finalizing the parameter values. Explicit user approval processes are further described below. In other examples (e.g., for certain types of functions that are not business-critical), no explicit user approval is needed, and the method 1400 proceeds from decision operation 1412 directly to operation 1418, and the function can be invoked without conducting operation 1416.

During parameter confirmation, the user may either confirm that one or more parameter values are correct, or change a previously provided or obtained value.

As mentioned, at operation 1418, any new or changed parameter values are stored by the digital assistant service system 126 (e.g., the conversation context is updated accordingly). For example, the digital assistant service system 126 can store an indication of the parameter values that have been validated, confirmed by the user, or both. The digital assistant service system 126 can also store an indication of parameter values that have been changed or newly provided, and that have not passed validation successfully at operation 1410. The method 1400 then proceeds to decision operation 1408, which is described further below.

Referring back to decision operation 1406, if no new or changed parameter values are identified by the digital assistant service system 126 at operation 1404, the digital assistant service system 126 moves from decision operation 1406 to decision operation 1408, where the digital assistant service system 126 checks whether all mandatory parameters have been confirmed.

In the context of decision operation 1408, “confirmed” may refer to explicit user confirmation, validation by the digital assistant service system 126, or both, depending, for example, on the type of function to be invoked. If not all mandatory parameters have been confirmed, the method 1400 moves back to operation 1404. If all mandatory parameters have been confirmed, the method 1400 concludes at closing loop operation 1420. At or after closing loop operation 1420, the selection function can then be invoked by the digital assistant service system 126 with its validated parameters, as described elsewhere herein.

The method 1400 may continue until all mandatory parameters are verified and until no changes are detected in the mandatory parameters (e.g., until the answer is “YES” at both decision operation 1406 and decision operation 1408). The validation processes in operation 1410 can thus be repeatedly performed as new information is obtained or values are adjusted.

A non-limiting example of a design-time specification for a scenario and a function is shown below. The scenario relates to fetching weather information for a city, and has validation operations attached thereto. The validation process for the digital assistant is structured to ensure that data used in executing a function is accurate and relevant.

In the example below, the “city” parameter is mandatory and the “location_ID” parameter is not mandatory. If the “location_ID” is not provided, the digital assistant service system 126 performs parameter-level validation to validate the “city.” If both the “city” and the “location_ID” are provided, cross-validation is performed to ensure that they match.

SCENARIO:

```
description: This function fetches the weather for a given
city
type: function
parameters:
  - name: city
    description: Weather information fetched for this city
    value help: show office locations #scenario
    validation: validate location #function
    optional: false
  - name: location_id
    description: Technical id for the city provided
    context path: context.weather.location_id
    optional: true
complex_validators:
  - name: id_matches_city
    parameters:
    - city
    - location_id
function:
  name: show_weather
```

FUNCTION:

```
parameters:
  - name: city
    optional: false
action_groups:
  - condition: location_id == null
    requires confirmation: false
    actions:
    - type: dialog-function
      name: weather/lookup_location
      parameters:
      - name: city
      value: “<? city ?>”
      result_variable: weather_location
    - type: api-request
    method: GET
    system_alias: WeatherService
    path: /forecast?placeid =<? weather_location.placeid
?>
    result_variable: weather_result
result:
  message_generation:
    - weather:
    data: <? weather_result.body ?>
    type: JSON
    description: The weather for the next 3 days
```

Referring again to explicit user confirmation processes, in some examples, user confirmation is employed in addition (or alternatively) to validation by the digital assistant service system 126, such as the validation process described in the method 1400 of FIG. 14. This can ensure that the generative machine learning model does not cause invocation of unwanted function calls, such as function calls with incorrect, LLM-generated data, or creates unwanted objects or transactions.

In some examples, the digital assistant service system 126 (e.g., the validation and confirmation component 214) performs the confirmation process without involvement from the generative machine learning model. For instance, once all mandatory parameter values are provided for a function, the digital assistant causes a confirmation request to be displayed in the web interface 132 at the user device 106, listing the parameter values and asking the user to provide positive confirmation thereof. In response to a positive confirmation, the digital assistant service system 126 triggers the function using the exact data as confirmed by the user in the confirmation operation. This ensures that there is no risk of the generative machine learning model altering any data that was already confirmed by the user.

At this stage, the digital assistant service system 126 can also store audit information for subsequent reproducibility of an executed action. For example, the digital assistant service system 126 can store a record in the database 130 of the parameter values that were presented to, and confirmed, by the user during the confirmation operation.

Using such techniques, business-critical responses or actions can be controlled to provide reliable and predictable outcomes, while still allowing users to leverage the power of generative AI. For example, critical responses or restricted actions can be explicitly defined to ensure that they are deterministically handled. This may mitigate the risk of model hallucination or unpredictability causing problems with respect to business-critical actions, such as creating incorrect business artifacts or incorrectly modifying data in a database.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one memory that stores instructions; and one or more processors configured by the instructions to perform operations comprising: selecting a set of functions from among a plurality of functions supported by a digital assistant; providing prompt data to a generative machine learning model, the prompt data comprising user input and function data, the user input being received from a user via a user interface of the digital assistant, and the function data identifying the set of functions and comprising dependency data that includes, at least one function dependency between a first function and a second function of the set of functions; invoking, based on a first response from the generative machine learning model, the first function to obtain first output data, the first response identifying the first function and being provided by the generative machine learning model based on inclusion of the at least one function dependency in the prompt data; invoking, based on a second response from the generative machine learning model received after updating the prompt data to include the first output data, the second function to obtain second output data; and causing presentation of at least one of the first output data or the second output data in the user interface associated with the digital assistant.

In Example 2, the subject matter of Example 1 includes, wherein the set of functions is selected from among the plurality of functions supported by the digital assistant based on at least one of the user input, a user profile of the user, previous interactions with the digital assistant, or function dependencies within the set of functions.

In Example 3, the subject matter of any of Examples 1-2 includes, wherein the at least one function dependency between the first function and the second function indicates that the first function is a helper function in relation to the second function, and the second response identifies the second function and includes at least a subset of the first output data as one or more parameter values for the second function.

In Example 4, the subject matter of any of Examples 1-3 includes, the operations further comprising: maintaining, for a digital conversation between the user and the digital assistant, model-accessible data and non-model-accessible data, the model-accessible data comprising the user input and the function data, and the non-model-accessible data comprising technical context data.

In Example 5, the subject matter of Example 4 includes, wherein the first function and the second function each has one or more parameters, the operations further comprising, for a parameter of the one or more parameters of the first function or the second function: identifying a context dependency of the parameter; and in response to identifying the context dependency, accessing the non-model-accessible data to obtain a parameter value for the parameter from the technical context data.

In Example 6, the subject matter of any of Examples 4-5 includes, wherein the first function and the second function each has one or more parameters, the operations further comprising, for a parameter of the one or more parameters of the first function or the second function: detecting that a parameter value for the parameter is not available within the technical context data of the non-model-accessible data; and in response to detecting that the parameter value for the parameter is not available within the technical context data, designating, in the function data, the parameter as a mandatory model-obtainable parameter.

In Example 7, the subject matter of any of Examples 4-6 includes, wherein the first function and the second function each has one or more parameters, the operations further comprising, for a parameter of the one or more parameters of the first function or the second function: detecting that a parameter value for the parameter is available within the technical context data of the non-model-accessible data; and in response to detecting that the parameter value for the parameter is available within the technical context data, designating, in the function data, the parameter as an optional model-obtainable parameter.

In Example 8, the subject matter of any of Examples 1-7 includes, wherein the prompt data further comprises at least one of a role definition for the generative machine learning model, a conversation history, or additional function data comprising a natural language description of one or more characteristics of each function in the set of functions.

In Example 9, the subject matter of any of Examples 1-8 includes, wherein the at least one function dependency comprises a first function dependency of a plurality of function dependencies in the function data, and the plurality of function dependencies is represented via a dependency relationship data structure.

In Example 10, the subject matter of Example 9 includes, wherein the prompt data comprises an instruction to the generative machine learning model to adhere to one or more relations defined by the dependency relationship data structure.

In Example 11, the subject matter of any of Examples 1-10 includes, wherein the first response comprises a first function call associated with the first function, the second response comprises a second function call associated with the second function, the first response comprises one or more first parameter values for one or more parameters of the first function, and the second response comprises one or more second parameter values for one or more parameters of the second function.

In Example 12, the subject matter of any of Examples 1-11 includes, the operations further comprising: identifying, in a conversation context for a digital conversation between the user and the digital assistant, a function selected by the generative machine learning model, the selected function being at least one of the first function or the second function; identifying, in the conversation context, one or more new or modified parameter values provided by the user for one or more parameters of the selected function; and invoking a validation function to validate the one or more new or modified parameter values against one or more predefined criteria.

In Example 13, the subject matter of Example 12 includes, the operations further comprising: detecting, after the invoking of the validation function, a failed validation; in response to detecting the failed validation, generating additional prompt data comprising details of the failed validation; providing the additional prompt data to the generative machine learning model to obtain a third response, the third response comprising a user-directed message related to the failed validation; and causing presentation of third output data comprising the user-directed message in the user interface associated with the digital assistant.

In Example 14, the subject matter of any of Examples 1-13 includes, the operations further comprising: prior to invoking the second function, causing presentation of a user-selectable approval element in the user interface together with a parameter value for one or more parameters of the second function; and receiving a user selection of the user-selectable approval element, wherein the second function is invoked in response to receiving the user selection of the user-selectable approval element.

Example 15 is a method comprising: selecting, by one or more processors, a set of functions from among a plurality of functions supported by a digital assistant; providing, by the one or more processors, prompt data to a generative machine learning model, the prompt data comprising user input and function data, the user input being received from a user via a user interface of the digital assistant, and the function data identifying the set of functions and comprising dependency data that includes, at least one function dependency between a first function and a second function of the set of functions; invoking by the one or more processors and based on a first response from the generative machine learning model, the first function to obtain first output data, the first response identifying the first function and being provided by the generative machine learning model based on inclusion of the at least one function dependency in the prompt data; invoking, by the one or more processors, based on a second response from the generative machine learning model received after updating the prompt data to include the first output data, the second function to obtain second output data; and causing, by the one or more processors, presentation of at least one of the first output data or the second output data in the user interface associated with the digital assistant.

In Example 16, the subject matter of Example 15 includes, maintaining, for a digital conversation between the user and the digital assistant, model-accessible data and non-model-accessible data, the model-accessible data comprising the user input and the function data, and the non-model-accessible data comprising technical context data.

In Example 17, the subject matter of Example 16 includes, wherein the first function and the second function each has one or more parameters, the method further comprising, for a parameter of the one or more parameters of the first function or the second function: identifying a context dependency of the parameter; and in response to identifying the context dependency, accessing the non-model-accessible data to obtain a parameter value for the parameter from the technical context data.

Example 18 is a non-transitory computer-readable medium that stores instructions that, when executed by one or more processors, cause the one or more processors to perform operations comprising: selecting a set of functions from among a plurality of functions supported by a digital assistant; providing prompt data to a generative machine learning model, the prompt data comprising user input and function data, the user input being received from a user via a user interface of the digital assistant, and the function data identifying the set of functions and comprising dependency data that includes, at least one function dependency between a first function and a second function of the set of functions; invoking, based on a first response from the generative machine learning model, the first function to obtain first output data, the first response identifying the first function and being provided by the generative machine learning model based on inclusion of the at least one function dependency in the prompt data; invoking, based on a second response from the generative machine learning model received after updating the prompt data to include the first output data, the second function to obtain second output data; and causing presentation of at least one of the first output data or the second output data in the user interface associated with the digital assistant.

In Example 19, the subject matter of Example 18 includes, the operations further comprising: maintaining, for a digital conversation between the user and the digital assistant, model-accessible data and non-model-accessible data, the model-accessible data comprising the user input and the function data, and the non-model-accessible data comprising technical context data.

In Example 20, the subject matter of Example 19 includes, wherein the first function and the second function each has one or more parameters, the operations further comprising, for a parameter of the one or more parameters of the first function or the second function: identifying a context dependency of the parameter; and in response to identifying the context dependency, accessing the non-model-accessible data to obtain a parameter value for the parameter from the technical context data.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

FIG. 15 is a block diagram showing a machine learning program 1500, according to some examples. Machine learning programs, also referred to as machine learning algorithms or tools, may be used as part of the systems described herein to perform one or more operations.

Machine learning is a field of study that gives computers the ability to learn without being explicitly programmed. Machine learning explores the study and construction of algorithms, also referred to herein as tools, that may learn from or be trained using existing data and make predictions about or based on new data. Such machine learning tools operate by building a model from example training data 1508 in order to make data-driven predictions or decisions expressed as outputs or assessments (e.g., assessment 1516). Although examples are presented with respect to a few machine learning tools, the principles presented herein may be applied to other machine learning tools.

In some examples, different machine learning tools may be used. For example, Logistic Regression (LR), Naive-Bayes, Random Forest (RF), neural networks (NN), matrix factorization, and Support Vector Machines (SVM) tools may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine learning program 1500 supports two types of phases, namely training phases 1502 and prediction phases 1504. In training phases 1502, supervised learning, unsupervised or reinforcement learning may be used. For example, the machine learning program 1500 (1) receives features 1506 (e.g., as structured or labeled data in supervised learning) and/or (2) identifies features 1506 (e.g., unstructured or unlabeled data for unsupervised learning) in training data 1508. In prediction phases 1504, the machine learning program 1500 uses the features 1506 for analyzing query data 1512 to generate outcomes or predictions, as examples of an assessment 1516.

In the training phase 1502, feature engineering is used to identify features 1506 and may include identifying informative, discriminating, and independent features for the effective operation of the machine learning program 1500 in pattern recognition, classification, and regression. In some examples, the training data 1508 includes labeled data, which is known data for pre-identified features 1506 and one or more outcomes. Each of the features 1506 may be a variable or attribute, such as individual measurable property of a process, article, system, or phenomenon represented by a data set (e.g., the training data 1508). Features 1506 may also be of different types, such as numeric features, strings, and graphs, and may include one or more of content 1518, concepts 1520, attributes 1522, historical data 1524 and/or user data 1526, merely for example.

The concept of a feature in this context is related to that of an explanatory variable used in statistical techniques such as linear regression. Choosing informative, discriminating, and independent features is important for the effective operation of the machine learning program 1500 in pattern recognition, classification, and regression. Features may be of different types, such as numeric features, strings, and graphs.

In training phases 1502, the machine learning program 1500 uses the training data 1508 to find correlations among the features 1506 that affect a predicted outcome or assessment 1516. With the training data 1508 and the identified features 1506, the machine learning program 1500 is trained during the training phase 1502 at machine learning program training 1510. The machine learning program 1500 appraises values of the features 1506 as they correlate to the training data 1508. The result of the training is the trained machine learning program 1514 (e.g., a trained or learned model).

Further, the training phases 1502 may involve machine learning, in which the training data 1508 is structured (e.g., labeled during preprocessing operations), and the trained machine learning program 1514 implements a relatively simple neural network 1528 capable of performing, for example, classification and clustering operations. In other examples, the training phase 1502 may involve deep learning, in which the training data 1508 is unstructured, and the trained machine learning program 1514 implements a deep neural network 1528 that is able to perform both feature extraction and classification/clustering operations.

A neural network 1528 generated during the training phase 1502, and implemented within the trained machine learning program 1514, may include a hierarchical (e.g., layered) organization of neurons. For example, neurons (or nodes) may be arranged hierarchically into a number of layers, including an input layer, an output layer, and multiple hidden layers. Each of the layers within the neural network 1528 can have one or many neurons and each of these neurons operationally computes a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which defines the influence of the input from a transmitting neuron to a receiving neuron.

In some examples, the neural network 1528 may also be one of a number of different types of neural networks, including a single-layer feed-forward network, an Artificial Neural Network (ANN), a Recurrent Neural Network (RNN), a symmetrically connected neural network, and unsupervised pre-trained network, a transformer network, a Convolutional Neural Network (CNN), or a Recursive Neural Network (RNN), merely for example.

During prediction phases 1504, the trained machine learning program 1514 is used to perform an assessment. Query data 1512 is provided as an input to the trained machine learning program 1514, and the trained machine learning program 1514 generates the assessment 1516 as output, responsive to receipt of the query data 1512.

In some examples, the trained machine learning program 1514 may be a generative AI model. Generative AI is a term that may refer to any type of AI that can create new content. For example, generative AI can produce text, images, video, audio, code, or synthetic data. In some examples, the generated content may be similar to the original data, but not identical.

Some of the techniques that may be used in generative AI are:
CNNs: CNNs may be used for image recognition and computer vision tasks. CNNs may, for example, be designed to extract features from images by using filters or kernels that scan the input image and highlight important patterns.
RNNs: RNNs may be used for processing sequential data, such as speech, text, and time series data, for example. RNNs employ feedback loops that allow them to capture temporal dependencies and remember past inputs.
GANs: GANs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code. For example, the LLM 118 of FIG. 1 or another LLM referred to herein may be a transformer model, or may be based on a transformer model. Non-limiting examples of LLMs that use transformer models include GPT-4 (Generative Pre-trained Transformer 4) developed by OpenAI™, BERT (Bidirectional Encoder Representations from Transformers) developed by Google™ LLAMA (Large Language Model Meta AI) developed by Meta™, PaLM2 (Pathways Language Model 2) developed by Google™, and Claude 3 developed by Anthropic™.

In generative AI examples, the assessment 1516 generated as a response or output by the trained machine learning program 1514 may include predictions, translations, summaries, answers to questions, suggestions, media content, or combinations thereof. For example, the LLM 118 of FIG. 1 may generate natural language responses in a conversational style, or the LLM 118 may generate function calls that align with a specific schema.

In some examples, a machine learning model may be fine-tuned. The term “fine-tuning,” as used herein, generally refers to a process of adapting a pre-trained machine learning model. For example, a machine learning model may be adapted to improve its performance on a specific task or to make it more suitable for a specific operation. Fine-tuning techniques may include one or more of updating or changing a pre-trained model's internal parameters through additional training, injecting new trainable weights or layers into the model architecture and training on those weights or layers, modifying a model topology by altering layers or connections, changing aspects of the training process (such as loss functions or optimization methods), or any other adaptations that may, for example, result in better model performance on a particular task compared to the pre-trained model.

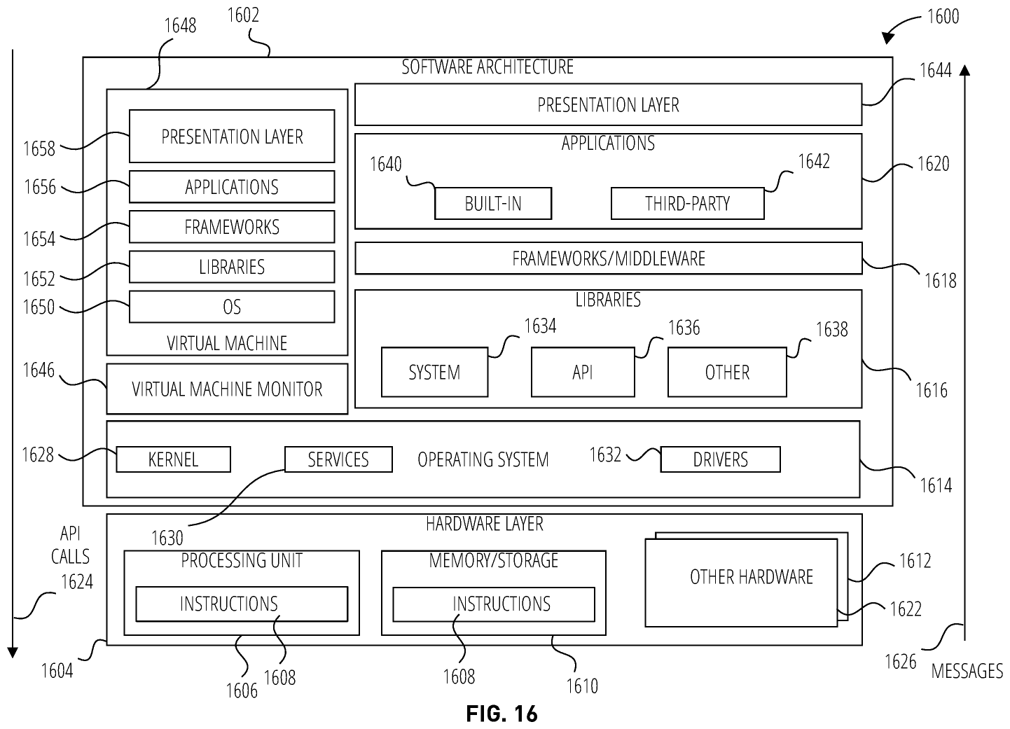

FIG. 16 is a block diagram 1600 showing a software architecture 1602 for a computing device, according to some examples. The software architecture 1602 may be used in conjunction with various hardware architectures, for example, as described herein. FIG. 16 is merely a non-limiting illustration of a software architecture, and many other architectures may be implemented to facilitate the functionality described herein. A representative hardware layer 1604 is illustrated and can represent, for example, any of the above referenced computing devices. In some examples, the hardware layer 1604 may be implemented according to the architecture of the computer system of FIG. 17.

The representative hardware layer 1604 comprises one or more processing units 1606 having associated executable instructions 1608. Executable instructions 1608 represent the executable instructions of the software architecture 1602, including implementation of the methods, modules, subsystems, and components, and so forth described herein and may also include memory and/or storage modules 1610, which also have executable instructions 1608. Hardware layer 1604 may also comprise other hardware as indicated by other hardware 1612 and other hardware 1622 which represent any other hardware of the hardware layer 1604, such as the other hardware illustrated as part of the software architecture 1602.

In the architecture of FIG. 16, the software architecture 1602 may be conceptualized as a stack of layers where each layer provides particular functionality. For example, the software architecture 1602 may include layers such as an operating system 1614, libraries 1616, frameworks/middleware layer 1618, applications 1620, and presentation layer 1644. Operationally, the applications 1620 or other components within the layers may invoke API calls 1624 through the software stack and access a response, returned values, and so forth illustrated as messages 1626 in response to the API calls 1624. The layers illustrated are representative in nature and not all software architectures have all layers. For example, some mobile or special purpose operating systems may not provide a frameworks/middleware layer 1618, while others may provide such a layer. Other software architectures may include additional or different layers.

The operating system 1614 may manage hardware resources and provide common services. The operating system 1614 may include, for example, a kernel 1628, services 1630, and drivers 1632. The kernel 1628 may act as an abstraction layer between the hardware and the other software layers. For example, the kernel 1628 may be responsible for memory management, processor management (e.g., scheduling), component management, networking, security settings, and so on. The services 1630 may provide other common services for the other software layers. In some examples, the services 1630 include an interrupt service. The interrupt service may detect the receipt of an interrupt and, in response, cause the software architecture 1602 to pause its current processing and execute an interrupt service routine (ISR) when an interrupt is accessed.

The drivers 1632 may be responsible for controlling or interfacing with the underlying hardware. For instance, the drivers 1632 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 1616 may provide a common infrastructure that may be utilized by the applications 1620 or other components or layers. The libraries 1616 typically provide functionality that allows other software modules to perform tasks in an easier fashion than to interface directly with the underlying operating system 1614 functionality (e.g., kernel 1628, services 1630 or drivers 1632). The libraries 1616 may include system libraries 1634 (e.g., C standard library) that may provide functions such as memory allocation functions, string manipulation functions, mathematic functions, and the like. In addition, the libraries 1616 may include API libraries 1636 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1616 may also include a wide variety of other libraries 1638 to provide many other APIs to the applications 1620 and other software components/modules.

The frameworks/middleware layer 1618 may provide a higher-level common infrastructure that may be utilized by the applications 1620 or other software components/modules. For example, the frameworks/middleware layer 1618 may provide various graphic user interface (GUI) functions, high-level resource management, high-level location services, and so forth. The frameworks/middleware layer 1618 may provide a broad spectrum of other APIs that may be utilized by the applications 1620 or other software components/modules, some of which may be specific to a particular operating system or platform.

The applications 1620 include built-in applications 1640 or third-party applications 1642. Examples of representative built-in applications 1640 may include, but are not limited to, a contacts application, a browser application, a book reader application, a location application, a media application, a messaging application, or a game application. Third-party applications 1642 may include any of the built-in applications as well as a broad assortment of other applications. In a specific example, the third-party application 1642 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1642 may invoke the API calls 1624 provided by the mobile operating system such as operating system 1614 to facilitate functionality described herein.

The applications 1620 may utilize built in operating system functions (e.g., kernel 1628, services 1630 or drivers 1632), libraries (e.g., system libraries 1634, API libraries 1636, and other libraries 1638), and frameworks/middleware layer 1618 to create user interfaces to interact with users of the system. Alternatively, or additionally, in some systems, interactions with a user may occur through a presentation layer, such as presentation layer 1644. In these systems, the application/module “logic” can be separated from the aspects of the application/module that interact with a user.

Some software architectures utilize virtual machines. In the example of FIG. 16, this is illustrated by virtual machine 1648. A virtual machine creates a software environment where applications/modules can execute as if they were executing on a hardware computing device. A virtual machine is hosted by a host operating system (operating system 1614) and typically, although not always, has a virtual machine monitor 1646, which manages the operation of the virtual machine as well as the interface with the host operating system (e.g., operating system 1614). A software architecture executes within the virtual machine 1648 such as an operating system 1650, libraries 1652, frameworks/middleware 1654, applications 1656 or presentation layer 1658. These layers of software architecture executing within the virtual machine 1648 can be the same as corresponding layers previously described or may be different.

Certain examples are described herein as including logic or a number of components, modules, or mechanisms. Modules or components may constitute either software modules/components (e.g., code embodied (1) on a non-transitory machine-readable medium or (2) in a transmission signal) or hardware-implemented modules/components. A hardware-implemented module/component is a tangible unit capable of performing certain operations and may be configured or arranged in a certain manner. In examples, one or more computer systems (e.g., a standalone, client, or server computer system) or one or more hardware processors may be configured by software (e.g., an application or application portion) as a hardware-implemented module/component that operates to perform certain operations as described herein.

In various examples, a hardware-implemented module/component may be implemented mechanically or electronically. For example, a hardware-implemented module/component may comprise dedicated circuitry or logic that is permanently configured (e.g., as a special-purpose processor, such as a field programmable gate array (FPGA) or an application-specific integrated circuit (ASIC)) to perform certain operations. A hardware-implemented module/component may also comprise programmable logic or circuitry (e.g., as encompassed within a general-purpose processor or another programmable processor) that is temporarily configured by software to perform certain operations. It will be appreciated that the decision to implement a hardware-implemented module/component mechanically, in dedicated and permanently configured circuitry, or in temporarily configured circuitry (e.g., configured by software) may be driven by cost and time considerations.

Accordingly, the term “hardware-implemented module” or “hardware-implemented component” should be understood to encompass a tangible entity, be that an entity that is physically constructed, permanently configured (e.g., hardwired), or temporarily or transitorily configured (e.g., programmed) to operate in a certain manner or to perform certain operations described herein. Considering examples in which hardware-implemented modules/components are temporarily configured (e.g., programmed), each of the hardware-implemented modules/components need not be configured or instantiated at any one instance in time. For example, where the hardware-implemented modules/components comprise, a general-purpose processor configured using software, the general-purpose processor may be configured as respective different hardware-implemented modules/components at different times. Software may accordingly configure a processor, for example, to constitute a particular hardware-implemented module/component at one instance of time and to constitute a different hardware-implemented module/component at a different instance of time.

Hardware-implemented modules/components can provide information to, and receive information from, other hardware-implemented modules/components. Accordingly, the described hardware-implemented modules/components may be regarded as being communicatively coupled. Where multiple of such hardware-implemented modules/components exist contemporaneously, communications may be achieved through signal transmission (e.g., over appropriate circuits and buses that connect the hardware-implemented modules/components). In examples in which multiple hardware-implemented modules/components are configured or instantiated at different times, communications between such hardware-implemented modules/components may be achieved, for example, through the storage and retrieval of information in memory structures to which the multiple hardware-implemented modules/components have access. For example, one hardware-implemented module/component may perform an operation, and store the output of that operation in a memory device to which it is communicatively coupled. A further hardware-implemented module/component may then, at a later time, access the memory device to retrieve and process the stored output. Hardware-implemented modules/components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules/components that operate to perform one or more operations or functions. The modules/components referred to herein may, in some examples, comprise processor-implemented modules/components.

Similarly, the methods described herein may be at least partially processor-implemented. For example, at least some of the operations of a method may be performed by one or more processors or processor-implemented modules/components. The performance of certain of the operations may be distributed among the one or more processors, not only residing within a single machine, but deployed across a number of machines. In some examples, the processor or processors may be located in a single location (e.g., within a home environment, an office environment, or a server farm), while in other examples the processors may be distributed across a number of locations.

The one or more processors may also operate to support performance of the relevant operations in a “cloud computing” environment or as a “software as a service (SaaS).” For example, at least some of the operations may be performed by a group of computers (as examples of machines including processors), these operations being accessible via a network (e.g., the Internet) and via one or more appropriate interfaces (e.g., APIs).

Examples may be implemented in digital electronic circuitry, or in computer hardware, firmware, or software, or in combinations of them. Examples may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In examples, operations may be performed by one or more programmable processors executing a computer program to perform functions by operating on input data and generating output. Method operations can also be performed by, and apparatus of some examples may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various examples.

FIG. 17 is a block diagram of a machine in the example form of a computer system 1700 within which instructions 1724 may be executed for causing the machine to perform any one or more of the methodologies discussed herein. In alternative examples, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1700 includes a processor 1702 (e.g., a central processing unit (CPU), a GPU, or both), a primary or main memory 1704, and a static memory 1706, which communicate with each other via a bus 1708. The computer system 1700 may further include a video display unit 1710 (e.g., a liquid crystal display (LCD) or a cathode ray tube (CRT)). The computer system 1700 also includes an alphanumeric input device 1712 (e.g., a keyboard or a touch-sensitive display screen), a UI navigation (or cursor control) device 1714 (e.g., a mouse), a storage unit 1716, a signal generation device 1718 (e.g., a speaker), and a network interface device 1720.

The storage unit 1716 includes a machine-readable medium 1722 on which is stored one or more sets of data structures and instructions 1724 (e.g., software) embodying or utilized by any one or more of the methodologies or functions described herein. The instructions 1724 may also reside, completely or at least partially, within the main memory 1704 or within the processor 1702 during execution thereof by the computer system 1700, with the main memory 1704 and the processor 1702 also each constituting a machine-readable medium 1722.

While the machine-readable medium 1722 is shown in accordance with some examples to be a single medium, the term “machine-readable medium” may include a single medium or multiple media (e.g., a centralized or distributed database, or associated caches and servers) that store the one or more instructions 1724 or data structures. The term “machine-readable medium” shall also be taken to include any tangible medium that is capable of storing, encoding, or carrying instructions 1724 for execution by the machine and that cause the machine to perform any one or more of the methodologies of the present disclosure, or that is capable of storing, encoding, or carrying data structures utilized by or associated with such instructions 1724. The term “machine-readable medium” shall accordingly be taken to include, but not be limited to, solid-state memories, and optical and magnetic media. Specific examples of a machine-readable medium 1722 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

The instructions 1724 may further be transmitted or received over a communications network 1726 using a transmission medium. The instructions 1724 may be transmitted using the network interface device 1720 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding, or carrying instructions 1724 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the inventive subject matter may be referred to herein, individually or collectively, by the term “example” merely for convenience and without intending to voluntarily limit the scope of this application to any single example or concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence. The term “operation” is used to refer to elements in the drawings of this disclosure for ease of reference and it will be appreciated that each “operation” may identify one or more operations, processes, actions, or steps, and may be performed by one or multiple components.

What is claimed is:

1. A system comprising:
at least one memory that stores instructions; and
one or more processors configured by the instructions to perform operations comprising:
selecting a set of functions from among a plurality of functions supported by a digital assistant;
providing prompt data to a generative machine learning model, the prompt data comprising user input and function data, the user input being received from a user via a user interface of the digital assistant, and the function data identifying the set of functions and comprising dependency data that includes at least one function dependency between a first function and a second function of the set of functions;
invoking, based on a first response from the generative machine learning model, the first function to obtain first output data, the first response identifying the first function and being provided by the generative machine learning model based on inclusion of the at least one function dependency in the prompt data;
invoking, based on a second response from the generative machine learning model received after updating the prompt data to include the first output data, the second function to obtain second output data; and
causing presentation of at least one of the first output data or the second output data in the user interface associated with the digital assistant.

2. The system of claim 1, wherein the set of functions is selected from among the plurality of functions supported by the digital assistant based on at least one of the user input, a user profile of the user, previous interactions with the digital assistant, or function dependencies within the set of functions.

3. The system of claim 1, wherein the at least one function dependency between the first function and the second function indicates that the first function is a helper function in relation to the second function, and the second response identifies the second function and includes at least a subset of the first output data as one or more parameter values for the second function.

4. The system of claim 1, the operations further comprising:
maintaining, for a digital conversation between the user and the digital assistant, model-accessible data and non-model-accessible data, the model-accessible data comprising the user input and the function data, and the non-model-accessible data comprising technical context data.

5. The system of claim 4, wherein the first function and the second function each has one or more parameters, the operations further comprising, for a parameter of the one or more parameters of the first function or the second function:
identifying a context dependency of the parameter; and
in response to identifying the context dependency, accessing the non-model-accessible data to obtain a parameter value for the parameter from the technical context data.

6. The system of claim 4, wherein the first function and the second function each has one or more parameters, the operations further comprising, for a parameter of the one or more parameters of the first function or the second function:
detecting that a parameter value for the parameter is not available within the technical context data of the non-model-accessible data; and
in response to detecting that the parameter value for the parameter is not available within the technical context data, designating, in the function data, the parameter as a mandatory model-obtainable parameter.

7. The system of claim 4, wherein the first function and the second function each has one or more parameters, the operations further comprising, for a parameter of the one or more parameters of the first function or the second function:
detecting that a parameter value for the parameter is available within the technical context data of the non-model-accessible data; and
in response to detecting that the parameter value for the parameter is available within the technical context data, designating, in the function data, the parameter as an optional model-obtainable parameter.

8. The system of claim 1, wherein the prompt data further comprises at least one of a role definition for the generative machine learning model, a conversation history, or additional function data comprising a natural language description of one or more characteristics of each function in the set of functions.

9. The system of claim 1, wherein the at least one function dependency comprises a first function dependency of a plurality of function dependencies in the function data, and the plurality of function dependencies is represented via a dependency relationship data structure.

10. The system of claim 9, wherein the prompt data comprises an instruction to the generative machine learning model to adhere to one or more relations defined by the dependency relationship data structure.

11. The system of claim 1, wherein the first response comprises a first function call associated with the first function, the second response comprises a second function call associated with the second function, the first response comprises one or more first parameter values for one or more parameters of the first function, and the second response comprises one or more second parameter values for one or more parameters of the second function.

12. The system of claim 1, the operations further comprising:
identifying, in a conversation context for a digital conversation between the user and the digital assistant, a function selected by the generative machine learning model, the selected function being at least one of the first function or the second function;
identifying, in the conversation context, one or more new or modified parameter values provided by the user for one or more parameters of the selected function; and
invoking a validation function to validate the one or more new or modified parameter values against one or more predefined criteria.

13. The system of claim 12, the operations further comprising:
detecting, after the invoking of the validation function, a failed validation;
in response to detecting the failed validation, generating additional prompt data comprising details of the failed validation;
providing the additional prompt data to the generative machine learning model to obtain a third response, the third response comprising a user-directed message related to the failed validation; and
causing presentation of third output data comprising the user-directed message in the user interface associated with the digital assistant.

14. The system of claim 1, the operations further comprising:
prior to invoking the second function, causing presentation of a user-selectable approval element in the user interface together with a parameter value for one or more parameters of the second function; and
receiving a user selection of the user-selectable approval element, wherein the second function is invoked in response to receiving the user selection of the user-selectable approval element.

15. A method comprising:
selecting, by one or more processors, a set of functions from among a plurality of functions supported by a digital assistant;
providing, by the one or more processors, prompt data to a generative machine learning model, the prompt data comprising user input and function data, the user input being received from a user via a user interface of the digital assistant, and the function data identifying the set of functions and comprising dependency data that includes at least one function dependency between a first function and a second function of the set of functions;
invoking by the one or more processors and based on a first response from the generative machine learning model, the first function to obtain first output data, the first response identifying the first function and being provided by the generative machine learning model based on inclusion of the at least one function dependency in the prompt data;
invoking, by the one or more processors, based on a second response from the generative machine learning model received after updating the prompt data to include the first output data, the second function to obtain second output data; and
causing, by the one or more processors, presentation of at least one of the first output data or the second output data in the user interface associated with the digital assistant.

16. The method of claim 15, further comprising:
maintaining, for a digital conversation between the user and the digital assistant, model-accessible data and non-model-accessible data, the model-accessible data comprising the user input and the function data, and the non-model-accessible data comprising technical context data.

17. The method of claim 16, wherein the first function and the second function each has one or more parameters, the method further comprising, for a parameter of the one or more parameters of the first function or the second function:
identifying a context dependency of the parameter; and
in response to identifying the context dependency, accessing the non-model-accessible data to obtain a parameter value for the parameter from the technical context data.

18. A non-transitory computer-readable medium that stores instructions that, when executed by one or more processors, cause the one or more processors to perform operations comprising:
selecting a set of functions from among a plurality of functions supported by a digital assistant;
providing prompt data to a generative machine learning model, the prompt data comprising user input and function data, the user input being received from a user via a user interface of the digital assistant, and the function data identifying the set of functions and comprising dependency data that includes at least one function dependency between a first function and a second function of the set of functions;
invoking, based on a first response from the generative machine learning model, the first function to obtain first output data, the first response identifying the first function and being provided by the generative machine learning model based on inclusion of the at least one function dependency in the prompt data;
invoking, based on a second response from the generative machine learning model received after updating the prompt data to include the first output data, the second function to obtain second output data; and
causing presentation of at least one of the first output data or the second output data in the user interface associated with the digital assistant.

19. The non-transitory computer-readable medium of claim 18, the operations further comprising:
maintaining, for a digital conversation between the user and the digital assistant, model-accessible data and non-model-accessible data, the model-accessible data comprising the user input and the function data, and the non-model-accessible data comprising technical context data.

20. The non-transitory computer-readable medium of claim 19, wherein the first function and the second function each has one or more parameters, the operations further comprising, for a parameter of the one or more parameters of the first function or the second function:
identifying a context dependency of the parameter; and
in response to identifying the context dependency, accessing the non-model-accessible data to obtain a parameter value for the parameter from the technical context data.
